(19) United States
(12) Patent Application Publication
(10) Pub. No.: US 2012/0116956 A1
(43) Pub. Date: May 10, 2012

(54) HYBRID MOBILE COMMERCE SYSTEM, APPARATUS, METHOD AND COMPUTER PROGRAM PRODUCT

(76) Inventors: Steven Altman, San Diego, CA (US); Andrew Altman, San Diego, CA (US); Robert Dessert, Canton, GA (US)

(21) Appl. No.: 13/212,950

(22) Filed: Aug. 18, 2011

Related U.S. Application Data
(60) Provisional application No. 61/411,564, filed on Nov. 9, 2010.

(51) Int. Cl. G06Q 40/00

(52) U.S. Cl. 705/39

(57) ABSTRACT

A method, system, apparatus, and computer program product are disclosed for a hybrid m-commerce system. Cash and electronic payment may be used substantially interchangeably within the hybrid m-commerce system. In one embodiment, cash change received from a transaction may be adjusted using the system. In another embodiment, cash change may be received as a change identifier. In yet another embodiment, a threshold may be defined and utilized to automatically adjust the balance of one or more stored value card account.

### CLAIM OF PRIORITY UNDER 35 U.S.C. §119

The present application for patent claims priority to Provisional Application No. 61/411,564 entitled “a Hybrid Mobile Commerce System, Method, Apparatus, and Computer Program Product” filed Nov. 9, 2010, and assigned to the assignee hereof and hereby expressly incorporated by reference herein.

### DESCRIPTION OF THE RELATED ART

Wireless devices are playing an increasingly important role in users' lives. Millions of people carry a wireless device with them at all times. While many simply use the calling functionality of the wireless device, more people are using their wireless devices to browse the web, read emails, purchase goods online, locate points-of-interest, etc. As the functionality of wireless devices increases, users will rely on the wireless for more than calling. In the near future, more wireless devices will have functionality to pay for goods and services using the wireless device as a payment means, which is often referred to as “mobile commerce” or “m-commerce.” However, cash will still be utilized extensively, especially for low-cost transactions. An opportunity exists to make cash transactions more efficient. Further, there exists and opportunity to improve the state of current m-commerce technology.

### BRIEF DESCRIPTION OF THE DRAWINGS

In the figures, like reference numerals refer to like parts throughout the various views unless otherwise indicated.

FIG. 1 depicts a hybrid m-commerce system;

FIG. 2A depicts a wireless device;

FIG. 2B depicts a computer;

FIG. 3A depicts a user module;

FIG. 3B depicts a server module;

FIG. 4 depicts a hybrid m-commerce system;

FIG. 5 depicts a process for adjusting a cash change amount;

FIG. 6 depicts a process for receiving a change identifier;

FIG. 7 depicts a process for transferring a balance to a stored value card account; and

FIG. 8A through FIG. 8I depict a series of screenshots and use cases of the hybrid m-commerce system in use.

### DETAILED DESCRIPTION

This detailed description is divided into various subsections to assist the reader in understanding the solutions proposed herein. The division between subsections does not import any limitation or substantive division among the subsections i.e. the detailed description should be viewed as a whole. The subsections are as follows: (1) terms of art, (2) existing problems and proposed solutions, (3) components of the proposed solutions, and (4) operation of the proposed solutions. To the extent possible, the components of the solutions will be described and defined earlier in the detailed description, and the operation of the components as part of the solutions will be described later in the detailed description.

### Terms of Art

In this description, the word “exemplary” is used herein to mean “serving as an example, an instance, or an illustration.” Any embodiment described herein as “exemplary” is not necessarily to be construed as preferred or advantageous over other embodiments.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed or processed.

In this description, the terms “component,” “module,” “system,” “record” and the like are intended to refer to a computer-related entity, which may be hardware, software, software in execution, or any combination thereof. For example, a component may be, but is not limited to be, a processor, a process running on a processor, an object, an executable, a thread of execution, a program, a computer, a wireless device, or any combination thereof. By way of illustration, both an application running on a computing device and the computing device may be a component. One or more components may reside within a process and/or thread of execution. One or more components may be localized on one computer and/or distributed among two or more computers. In addition, these components may execute from various computer-readable media having various data structures stored thereon. The components may communicate by way of local and/or remote processes.

In this description, the terms “electronic device,” “communication device,” “wireless device,” “wireless telephone,” “wireless communications device,” and “wireless handset,” and “computing device” are used interchangeably. A wireless device may be a cellular telephone, a pager, a personal digital assistant (“PDA”), a smartphone, a navigation device, or a computer with a wireless connection.

A “web-based interface” as described herein could be based on any of the following technologies: HyperText Markup Language (“HTML”), Extensible HyperText Markup Language (“XHTML”), Really Simple Syndication (“RSS”), Extensible Markup Language (“XML”), Wireless Markup Language (“WML”), Javascript, Ruby on Rails, PHP, Adobe® Flash, Asynchronous JavaScript and XML-based (“Ajax”), Scalable Vector Graphics (“SVG”), etc.

Cash may be money represented in physical form. Cash may be supported by a local government. Cash represents a small fraction of the money supply in more modernized economies. Cash may be physically embodied as banknotes or coins. Banknotes may be constructed from paper, cloth, or combination thereof. Coins may be constructed from metal or other durable substance. Metal coins may be minted from precious metals, inexpensive metals, synthetic material, or combination thereof.

Change is an amount of money resulting from a cash transaction. Change may be a fractional dollar amount, whole dollar amount, or combination thereof. For example, $0.32 USD change is a fractional dollar amount of change. Further, $1.00 USD change is a whole dollar amount of change. Even further, $1.32 USD change is a fractional and whole dollar amount of change. Change may be payable using banknotes, coins, or combination thereof. Most commonly, fractional dollar amounts are payable using coins and whole dollar amounts are payable using banknotes.

A stored value card account is a financial account associated with a balance of money. The stored value card account may be associated with one or more merchants. In one embodiment, the stored value card account's balance may be accessible by using a stored value card. A stored value card may resemble a plastic credit card. The stored value card may have a magnetic stripe, smart chip, secure element, 1-D barcode, 2-D barcode, scratch-off secure code, etc., all of which may be utilized to communicate with points-of-sale and process payment. Stored value cards may not have a name or other identification printed on them and thus may be used by anyone. Some stored value cards may only be used to complete purchases whereas other stored value cards may be “reloaded” by merchants when the consumer contributes additional funds to the stored value card account.

Stored value cards may be “open looped” or “closed loop.” Open loop stored value cards may be used at any merchant which accepts a third-party credit card payment system. Closed loop stored value cards are associated with one or more merchants and thus may only be accepted at such merchants. In this description, the terms “stored value card,” “gift card,” “electronic gift certificate,” “digital gift card,” “prepaid credit card,” and “prepaid debit card,” are used interchangeably.

A stored value card account may be “branded” and associated with a particular merchant (e.g., Target, Walmart, Amazon.com, etc.). Alternatively, a stored value card account may be “unbranded” and not associated with a particular merchant. As used herein, the terms “unbranded stored value card account” and “unbranded account” are used interchangeably.

### Existing Problems and Proposed Solutions

M-commerce will continue to grow and reach more consumers and merchants because of its many advantages. However, cash will exist in any civilized economy because cash serves far too many human needs, which are uniquely addressed by cash's simplistic design. In short, m-commerce and cash will need to co-exist for many decades to come. An opportunity exists to enable efficient cash transactions within an m-commerce system.

Before discussing m-commerce and its advantages, cash's characteristics shall be discussed. Cash is simple and ancient. Historians estimate that cash dates back to 3,000 B.C. Use of cash requires no contractual relationship with a third-party financial institution (e.g., Visa, Mastercard, Wells Fargo Bank, etc.). Cash may be untraceable and may provide consumers with a desired sense of anonymity. However, the simplicity of cash yields some disadvantages.

Cash may encourage crime. Cash is generally untraceable when used in normal commerce, especially in developing nations. As such, cash is often employed by criminals and the black market because it does not create a paper trail. Law enforcement agencies would more easily track criminal and terrorist activity if more and more transactions were conducting using electronic commerce means.

Cash transactions may result in tax evasion. The United States has a self-reporting income system which requires individuals and businesses to report income. Thus, cash transactions which result in income are reportable tax events. In the normal course of business, a merchant will maintain accounting records to report income to the proper tax authority (e.g., the United States Internal Revenue Service). However, cash transactions are highly untraceable, especially for low-cost goods or services. Therefore, many merchants simply keep the cash and do not report the income to the government, which results in loss of tax revenue for the government.

Cash is difficult to count and may result in consumers receiving the incorrect amount of change resulting from a cash transaction. Computers are well-designed to count and calculate numeric values. Humans are not as reliable. Even with the assistance of an electronic cash register, the human operator will invariably miscount the change due to the consumer. Miscounting change may lead to loss of revenue for the merchant and consumer dissatisfaction.

Cash is vulnerable to theft. Since cash is generally untraceable, cash may be stolen. Any cash kept on the premises of a merchant is subject to theft by street criminals or employees of the merchant who embezzle.

Cash is expensive to maintain. Governments must incur the expense of minting cash, which is passed onto the taxpayer. Since cash is physical in nature, cash must be constructed from physical materials. In short, cash costs money. In 2008, the cost to manufacture a penny (a U.S. coin valued at $0.01 USD) was approximately $0.0126 USD, which is more than the face value of the coin. Further, governments must address the collection and reissuance of existing cash (e.g., shredding paper currency, melting coins, printing paper currency, minting coins, etc.). Since cash costs money, dollarization occurs in developing nations that use U.S. currency as their primary currency.

Cash creates overhead for merchants which is passed onto the consumers. Paper and coin currency are physical objects which must be secured, transported, stored, counted, etc., all of which have a real-world cost. Merchants pass the costs of handling cash on to their customers. Some experts estimate that a family may incur $250 USD per year in indirect costs related to the handling of cash. In fact, some merchants offer cashback when users pay with debit card to help the merchant offload its cash on the customers to avoid incurring cash handling costs.

M-commerce addresses many of the disadvantages of cash because m-commerce is traceable, secure, safe, and efficient. M-commerce transactions are traceable because they may pass through a central server which reconciles transactions. As such, all transactions through an m-commerce system are traceable by governments, businesses, and individual consumers with proper credentials. As such, criminal activities may be traced if they are conducted via an m-commerce system. Likewise, tax evasion may be reduced if conducted through an m-commerce system.

M-commerce transactions may be more secure than cash transactions. Unlike cash, a balance held in an m-commerce system may not be physically stolen.

M-commerce may be safer for society rather than cash transactions. Theft of cash may result in violent crimes conducted against the victim. One skilled in the art will appreciate that m-commerce systems may be vulnerable to hacking, phishing, and fraud, but such crimes are much less violent than larceny, burglary, robbery, etc.

M-commerce may be more efficient than using cash. As stated, governments incur costs related to maintaining cash. If more and more consumers switch to m-commerce, the government will need to mint less cash saving the taxpayers money. Likewise, merchants incur costs related to handling cash. These costs may be reduced as m-commerce is more widely adopted and the fees associated with using electronic payments continue to decline. Further, merchants may reap financial savings by not having to train cashiers to count, sort, and protect cash.

One of skill in the art will appreciate that m-commerce has many advantages which may address some shortcomings of cash. However, widespread m-commerce adoption will not happen immediately. Further, even if m-commerce dominates most financial transactions, cash will always have a place in any civilized economy. An opportunity exists to enable m-commerce while still allowing cash transactions.

As an illustrative example, assume Dave is a consumer who enjoys coffee. Dave has a wallet which contains approximately $600 USD in various denominations, having won some cash in Las Vegas. Further, Dave's wallet has a credit card, a Coffee Co. gift card, a driver's license, and a picture of his girlfriend Cynthia. Dave also keeps a wireless device in his front jean pocket, which he uses to surf the web and send text messages to his girlfriend. Dave's personal belongings and affinity for coffee are quite common in the United States. Note that Dave is not carrying coin currency because Dave, like many people, does not like carrying coin change, especially as society becomes more cashless.

Dave would like to buy a medium mocha from Coffee Co., but he would like to avoid receiving coin change. Given the contents of Dave wallet, he has some options, all of which shall be discussed.

First, Dave could pay with his credit card. Paying with credit card may not always be desirable. For example, Dave may already have a large balance on his credit card from his last trip to Las Vegas, Nev. As such, he may want to avoid “over limit” fees resulting from charging a balance in excess of the contractually established limit. Further, Dave has been unable to pay down his credit card balance and knows that he will be paying a relatively high-interest rate to finance his caffeine addiction. Even though paying with the credit card will meet Dave's requirement of having no coin currency change result from the transaction, Dave cannot bear the other associated costs of using the credit card. Therefore, Dave must consider his other options.

Second, Dave could pay for the mocha using the cash in his wallet. However, Dave is carrying no coin currency and will not be able to make exact change. Therefore, Dave will receive coin currency change from the transaction. Thus, Dave must consider his other options.

Third, Dave could pay using his Coffee Co. gift card, but the balance is only $2.43 USD while the mocha costs $4.59 USD. Therefore, even if Dave uses the Coffee Co. gift card, he will still need to pay the additional balance of $2.16 USD using either cash or his credit card. The former will result in coin cash change, and the latter has the disadvantages described above. Therefore, Dave must consider his other options.

Fourth, Dave could pay using cash and leave the coin cash change in a tip jar. While this option may normally meet Dave's requirement of not receiving coin currency, it assumes that Dave would like to tip the cashier. Further, it assumes that there is a tip jar which may not always be the case. In this example, Dave has received poor service and would rather not tip. Thus, Dave must consider his other options.

In sum, given what is in his wallet, Dave will likely receive coin currency from the transaction. Dave gives up and chooses the last option and opts to pay using his cash because as previously stated, cash is simple and ancient. Dave begrudgingly leaves the change in the tip jar even though he received poor service and continues on with his day. Dave received his coffee but did so in a manner than caused him internal turmoil. Dave would have been more satisfied if he: (1) did not receive coin change, (2) could have used his Coffee Co. gift card balance, and (3) had more control in general over the manner in which he pays for goods and services.

Likewise, the merchant failed to perceive a potential market opportunity by addressing Dave's payment requirements. The merchant had an opportunity to utilize m-commerce and cashless systems to create and track customer loyalty. Further, the merchant accepted more cash than was necessary to complete the transaction. As stated, handling cash is expensive for merchants and may lead to criminal activities. The merchant will need to closely monitor the tip jar to comply with tax reporting requirements. Further, the merchant must be vigilant against embezzlement by employees.

What is needed is a hybrid m-commerce system for handling cash payments and stored value card account balances. In one embodiment, the hybrid m-commerce system is operable to manage a plurality of stored value card account balances, any of which may be accessible by a consumer. The hybrid m-commerce system may allow the consumer to exchange stored value card balances between two stored value accounts. Further, the balances of any stored value card account may be transferred to an unbranded stored value card account. The hybrid m-commerce system may allow conversion from the unbranded account to a stored value card account accessible on a wireless device. In one embodiment, if cash is used in a financial transaction, the hybrid m-commerce system may allow partial payment from a stored value card account to eliminate (or reduce) an amount of cash change due from the cash transaction. In another embodiment, if cash is used, a merchant may transfer the change amount due to a stored value card account using the hybrid m-commerce system and existing points-of-sale. In yet another embodiment, if the stored value card account balance goes below a threshold, the stored value card account balance may be automatically transferred to the unbranded account such that the funds may be transferred to another stored value card account and subsequently used with a merchant.

### Components of the Proposed Solutions

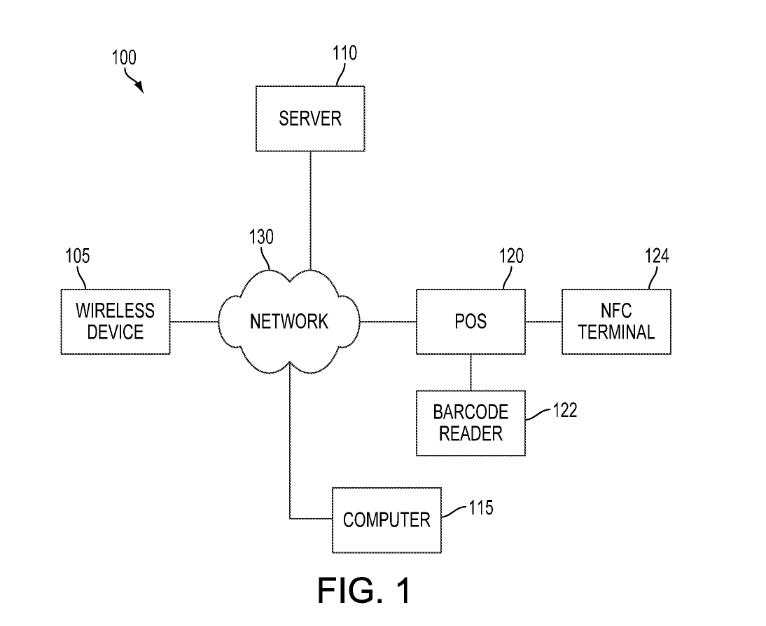

The various components of the proposed solutions will be described in further detail. Turning to FIG. 1, a hybrid m-commerce system 100 is depicted. A wireless device 105 may be connected to a network 130. In one embodiment, the wireless device 105 may be connected to the network 130 using any one of code division multiplexed access (“CDMA”), time division multiplexed access (“TDMA”), frequency division multiplexed access (“FDMA”), orthogonal frequency division multiplexed access (“OFDMA”), global system for mobile communications (“GSM”), Analog Advanced Mobile Phone System (“AMPS”), Universal Mobile Telecommunications System (“UMTS”), 802.11a/b/n (“WiFi”), World Interoperability for Microwave Access (“WiMAX”), Long Term Evolution (“LTE”), Bluetooth, near-field communication (“NFC”) or other wireless communication technology. In yet another embodiment, the wireless device 105 may be connected to a docking station (not shown), which may be connected to the network 130.

Many commercial versions of the wireless device 105 may be found in the marketplace today. For example, the wireless device 105 may be a Google® Nexus One™ device, an Apple® iPhone® device, an HTC® Incredible™ device, a LG®, Dare™ device, a Blackberry® Storm™ device, a Motorola® Droid X™ device, a Samsung® Omnia™ II device, etc. One of skill in the art will appreciate that the foregoing enumeration of wireless devices is illustrative and not exhaustive.

The network 130 may be the Internet in one embodiment. The Internet is a world-wide, redundant network of computers utilizing the Internet Protocol (“IP”). In another embodiment, the network 130 may be a local area network (“LAN”) with wireless capabilities (e.g., a local WiFi hotspot). In yet another embodiment, the network 130 may be a subscription-based network operated by a wireless carrier (e.g., Verizon, Sprint, T-Mobile, AT&T, etc.).

A server 110 may be connected to the network 130. The server 110 may manage the hybrid m-commerce system 100. In one embodiment, the server 110 may be a stand-alone network server capable of serving many user clients and connections. As more computing moves into the “cloud,” the server 110 may be embodied as rented time-slices of memory, processing, and storage space, all of which are allocated among several computers. The Amazon® Elastic Compute Cloud is an example of cloud-based computing.

A computer 115 may be connected to the network 130. In one embodiment, the computer 115 may be a personal computer or a laptop computer. The definition of a personal computer is currently in a state of flux as more devices challenge consumers' definitions and conceptions of computing. For example, the Nexus One™ device developed by Google is a wireless device, which is very similar in processing capability to a standard personal computer. Further, more and more consumers are relying on their wireless devices to perform functionality traditionally performed on a personal computer. Thus, the computer 115 is shown as being a separate entity from the wireless device 105, but in some embodiments, the wireless device 105 and the computer 115 may be used interchangeably. Popular manufacturers of computer hardware and software include Dell, Microsoft, HP, Apple, Intel, Nvidia, Acer, Lenovo, etc.

A point-of-sale terminal 120 may be connected to the network 130. In one embodiment, the point-of-sale terminal 120 may be a collection of hardware and software that allows a merchant to register (or “ring up”) a sale of goods and/or services. One of skill in the art may refer to the point-of-sale terminal 120 as an electronic cash register, which may be a misnomer because many points-of-sale are cashless and process transactions electronically. The point-of-sale terminal 120 may be operated by a store clerk or cashier. In one embodiment, the point-of-sale terminal 120 is operated by the consumer, which is commonly referred to as “self checkout.” The point-of-sale terminal 120 may be equipped with a display (not shown) to provide feedback to the store clerk and/or the consumer. Common manufactures of point-of-sale hardware and software include Microsoft, NCR, Epson, Fujitsu-ICL, Radiant/Aloha, Micros, Citadel, IBM, etc.

The point-of-sale terminal 120 may be connected to a barcode reader 122. The barcode reader 122 may be a pen-type reader, a laser scanner, a camera-based reader, a charged coupled device (“CCD”) device, an omni-directional scanner, etc. The barcode reader 122 may be housed in a fixed housing near the point-of-sale terminal 120. In one embodiment, the barcode reader 122 may be housed in a wireless device. The barcode reader 122 may be operable to read one-dimensional barcodes (e.g., UPC-A). Exemplary one-dimensional barcodes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, Telepen, etc.

In another embodiment, the barcode reader 122 may be operable to read two-dimensional barcodes (e.g., MaxiCode). The two-dimensional barcode may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, etc.

The point-of-sale terminal 120 may be connected to a near-field communication (“NFC”) terminal 124. NFC is a short-range communication technology which allows two devices to exchange data within a range of approximately 10 centimeters (approximately 3.94 inches). Currently, NFC is not supported by many commercial wireless devices. However, more and more wireless devices will be including support for NFC. Likewise, more point-of-sale terminals 120 will have support for NFC and NFC-based transactions. Thus, it is envisioned that point-of-sale terminals 120 and wireless devices 105 may be able to communicate with one another to securely conduct electronic commerce wirelessly using NFC. In one embodiment, the NFC terminal 124 may simply be a contactless terminal commonly used throughout the United States for payment and identification.

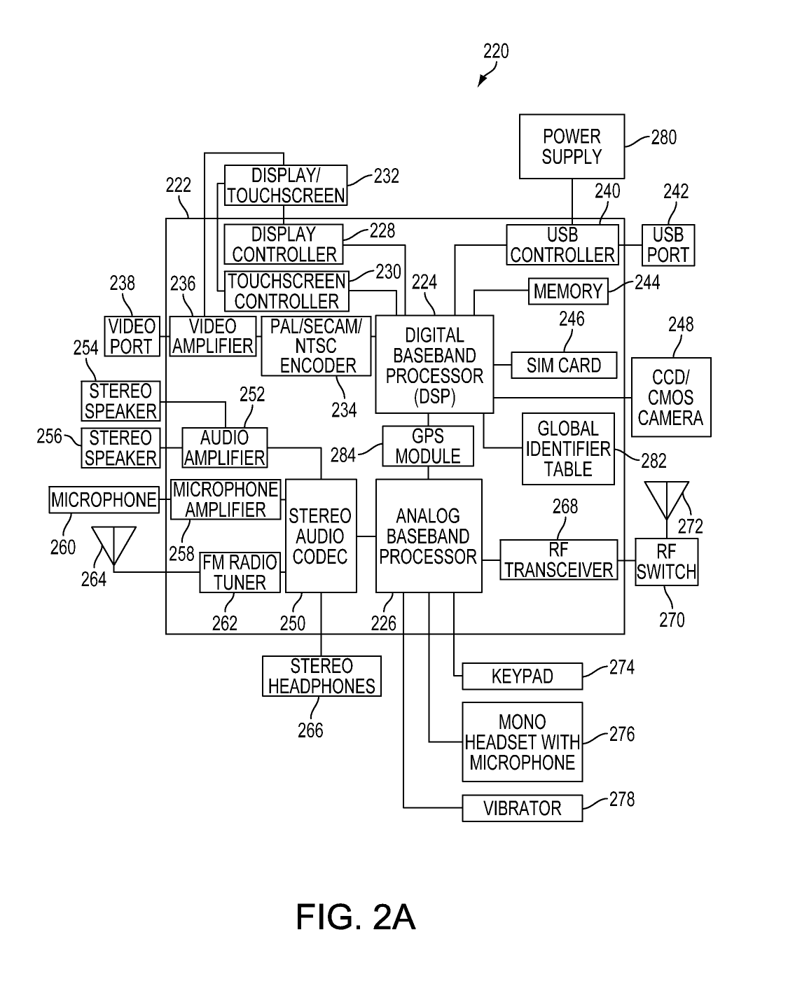

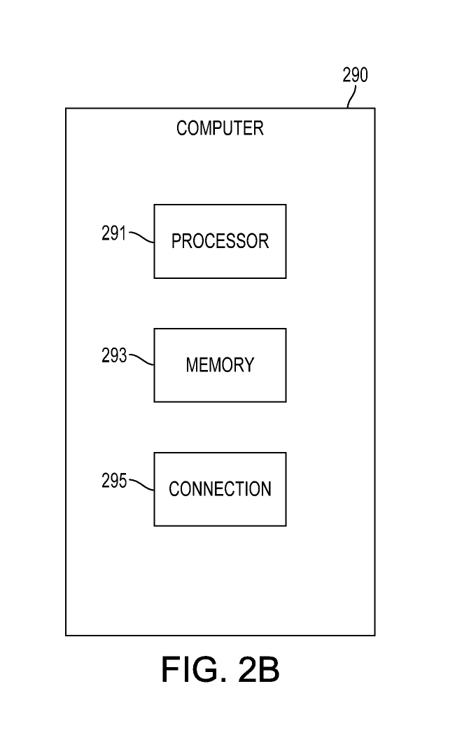

Turning to FIG. 2A, a wireless device 205 is depicted. As shown, the wireless device 205 includes an on-chip system 222 that includes a digital baseband processor 224 and an analog baseband processor 226 that may be coupled together.

As illustrated in FIG. 2A, a display controller 228 and a touchscreen controller 230 may be coupled to the digital baseband processor 224. In turn, a touchscreen display 232 external to the on-chip system 222 may be coupled to the display controller 228 and the touchscreen controller 230.

FIG. 2A further depicts a video encoder 234, e.g., a phase alternating line (“PAL”) encoder, a sequential couleur a memoire (“SECAM”) encoder, or a national television system(s) committee (“NTSC”) encoder, may be coupled to the digital baseband processor 224. Further, a video amplifier 236 may be coupled to the video encoder 234 and the touchscreen display 232. Also, a video port 238 may be coupled to the video amplifier 236. As depicted in FIG. 2A, a universal serial bus (“USB”) controller 240 may be coupled to the digital baseband processor 224. Also, a USB port 242 may be coupled to the USB controller 240. A memory 244 and a subscriber identity module (“SIM”) card 246 may also be coupled to the digital baseband processor 224. Further, as shown in FIG. 2A, a digital camera 248 may be coupled to the digital baseband processor 224. In one embodiment, the digital camera 248 may be a charge-coupled device (“CCD”) camera or a complementary metal-oxide semiconductor (“CMOS”) camera.

As further depicted in FIG. 2A, a stereo audio CODEC 250 may be coupled to the analog baseband processor 226. Moreover, an audio amplifier 252 may coupled to the stereo audio CODEC 250. In one embodiment, a first stereo speaker 254 and a second stereo speaker 256 may be coupled to the audio amplifier 252. FIG. 2A depicts how a microphone amplifier 258 may be also coupled to the stereo audio CODEC 250. Additionally, a microphone 260 may be coupled to the microphone amplifier 258. In one embodiment, a frequency modulation (“FM”) radio tuner 262 may be coupled to the stereo audio CODEC 250. Also, an FM antenna 264 may be coupled to the FM radio tuner 262. Further, stereo headphones 266 may be coupled to the stereo audio CODEC 250.

FIG. 2A further depicts how a radio frequency (“RF”) transceiver 268 may be coupled to the analog baseband processor 226. An RF switch 270 may be coupled to the RF transceiver 268 and an RF antenna 272. As depicted in FIG. 2A, a keypad 274 may be coupled to the analog baseband processor 226. Also, a mono headset with a microphone 276 may be coupled to the analog baseband processor 226. Further, a vibrator device 278 may be coupled to the analog baseband processor 226. FIG. 2A also depicts that a power supply 280 may be coupled to the on-chip system 222. In one embodiment, the power supply 280 may be a direct current (“DC”) power supply that provides power to the various components of the wireless device 205. Further, in one embodiment, the power supply may be a rechargeable DC battery or a DC power supply that is derived from an alternating current (“AC”) to DC transformer that is connected to an AC power source.

In one embodiment, the wireless device 205 may include a global positioning system (“GPS”) module 284 coupled to the digital baseband processor 224 or the analog baseband processor 226. The GPS module 284 and at least one of the processors 224, 226 may be utilized to locate the wireless device 205.

As depicted in FIG. 2A, the touchscreen display 232, the video port 238, the USB port 242, the camera 248, the first stereo speaker 254, the second stereo speaker 256, the microphone 260, the FM antenna 264, the stereo headphones 266, the RF switch 270, the RF antenna 272, the keypad 274, the mono headset 276, the vibrator 278, and the power supply 280 may be external to the on-chip system 222.

Turning to FIG. 2B, a computer 290 is depicted. The computer 290 may have a processor 291, a memory 293, and a connection 295. The processor 291 may be configured by software instructions to perform a variety of methods, including the methods of the various embodiments described herein. For example, the processor 291 may comprise a general purpose processor (e.g., x86, ARM, etc.), a digital signal processor (“DSP”), an application specific integrated circuit (“ASIC”), a field programmable gate array (“FPGA”), etc.

The memory 293 may be any optical disk storage, any magnetic disk storage, or any other medium operable to store logic and/or data accessible by the computer 290. The memory 293 may comprise random access memory (“RAM”), read-only memory (“ROM”), electrically erasable programmable read-only memory (“EEPROM”), compact-disc read-only memory (“CD-ROM”), digital video disc read-only memory (“DVD ROM”), solid-state memory, etc.

The connection 295 may generally allow connectivity to other computers, wireless devices, laptops, servers, etc. The connection 295 may comprise a network interface card (“NIC”), a modem, a universal serial bus port (“USB”), a Firewire port, a 3G/4G wireless modem, a near-field communication connection (“NFC”), etc. The connection 295 may be any other wired connection, any other wireless connection, any other magnetic connection, any other visual connection, any other audible connection, etc.

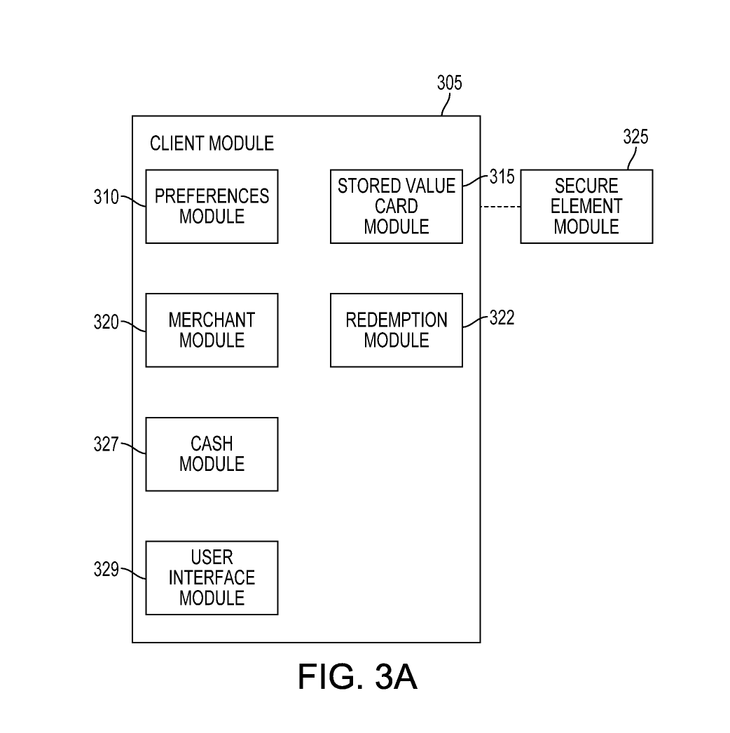

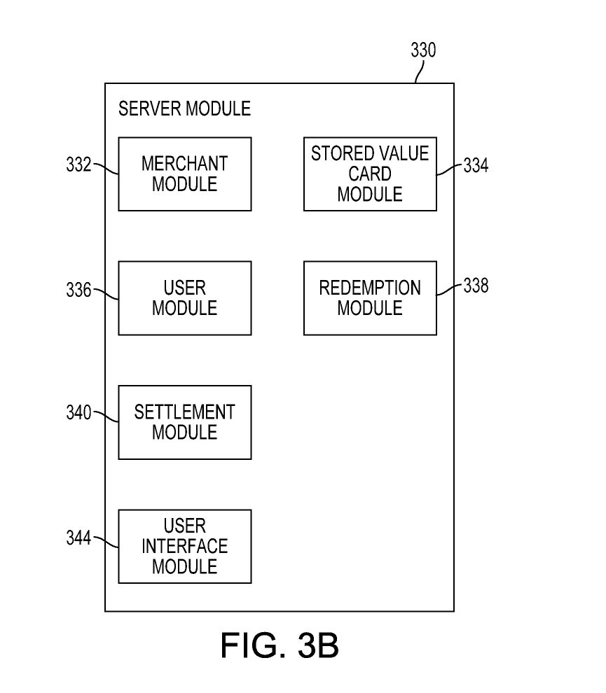

Turning to FIG. 3A, depicts a client module 305. In general, the client module 305 is operable to provide functionality to the user of the hybrid m-commerce system 100. In one embodiment, the client module 305 may be installed in the user's wireless device 105 as a downloadable application. Thus, the client module 305 may be written using common programming languages (e.g., C/C++, Objective C, Adobe® Actionscript, etc.). Further, the client module 305 may operate on common application platforms (e.g., Apple® iOS, Android, BREW MP, Blackberry OS, Windows Mobile, etc.).

The client module 305 may be downloaded and installed to the wireless device 105. One of skill in the art will appreciate that a number of methods exist for transmitting and installing applications on wireless devices. In one embodiment, the client module 305 may be sent to the wireless device 105 via a WAP push request from the server 110. In another embodiment, wireless device users may be able to acquire applications via application stores (commonly referred to as “app stores”). Providers of application stores are Apple, Microsoft, Electronic Arts (“EA”), Valve, Stardock, Handango, Verizon, Sprint, AT&T, Alltel, Nokia, Samsung, LG, etc. The applications may be free or purchased for money. The application store may wirelessly transmit the application to the wireless device 105 for installation.

Alternatively, the application may be transmitted via a cable (not shown) connected to the computer 115 (e.g., a personal computer, a laptop, a kiosk, etc.). In yet another embodiment, applications may be transmitted “virally” from one wireless device to another wireless device (sometimes referred to as “superdistribution”). One of skill in the art may include any number of digital rights management (“DRM”) schemes to protect the client module 305 from unauthorized copying or use.

Turning to the specifics of the client module 305, a preferences module 310 may allow preferences to be defined. The preferences may be set by the user, the merchant, the wireless carrier, the financial institution, etc. In one embodiment, the preferences module 310 may be connected to the server 110 which stores preferences across devices and platforms. In another embodiment, the preferences module 310 may contain preferences relating to the form of cash change to be received from a cash-based transaction. In yet another embodiment, the preferences module 310 is operable to store a threshold value for one or more stored value accounts.

A stored value card module 315 is generally operable to manage the stored value card accounts associated with the client module 305. In one embodiment, the stored value card module 315 communicates with the server 110 such that the quantity of personal financial information within the client module 305 is minimized. Further, communication with the server 110 may reduce fraud or hacking because information is validated remotely. The stored value card module 315 may in one example contain a merchant. For example, the stored value card module 315 may have a Target® account, a Vons® account, a Starbucks® account, etc., any of which may have a balance and other data. If the stored value card account is not associated with a merchant, the stored value account is considered “unbranded” as described herein.

The stored value card module 315 may communicate with a merchant module 320. In one embodiment, the stored value card account may be associated with a particular merchant. As such, additional data may be retrieved from the merchant module 320.

The merchant module 320 may be generally operable to manage data related to merchants. In one embodiment, the merchant module 320 is operable to assist the client module 305 to locate a merchant based on a preference stored in the preference module 310. For example, if the client module 305 is instructed to locate a nearby coffee shop, the merchant module 320 may utilize global positioning system (“GPS”) information and a database (e.g., the yellow pages, Yelp, Google® Maps, etc.) to locate a nearby coffee shop. The merchant module 320 may store additional information related to the merchant such as: name, address, customer reviews, photographs, video clips, prices, menus, etc.

In one embodiment, the preferences module 310 may interact with the merchant module 320 such that the user can “bookmark” a merchant as being a favorite. At a later time, the user can easily recall favorite merchants using the bookmark.

A redemption module 322 may be responsible for communicating information related to the transfer of funds to or from the stored valued card accounts. The redemption module 322 may be generally operable to communicate with a merchant to redeem a stored value card account balance. In one embodiment, the redemption module 322 may communicate with a merchant's point-of-sale 120 via NFC to transfer an amount of money from a stored value card account to the merchant's account. In another embodiment, the redemption module 322 may be operable to communicate a balance using a barcode shown on the display of the wireless device 105. The barcode may then be scanned and redeemed at the merchant. Thus, the redemption module 322 may frequently be in communication with the stored value card module 315 in order to update the stored value account balances.

In one embodiment, the redemption module 322 may be operable to redeem a “change identifier.” The change identifier may be associated with an amount having a cash value such that the amount may be added to one or more stored value card accounts. For example, the change identifier may be expressed as a code, a barcode, a non-human readable code, etc. In one embodiment, the redemption module 322 may communicate with the NFC terminal 124 to securely transfer an amount of money from the merchant to a stored value card account. In another embodiment, the redemption module 322 may decipher a change identifier code to transfer an amount of money from the merchant to the stored value card account.

A cash module 327 may be generally operable to determine amounts of cash change due and adjusting amounts of cash change resulting from a cash transaction. The cash module 327 may contain logic to determine the fewest number of banknotes required to reconcile an amount of cash change. For instance, the user may enter in the preferences module 310 that larger bills are preferable to smaller bills. The cash module 327 may utilize this preference as a heuristic to determine the form of cash change payment. For example, if the cash change due is $10.00 USD, the cash module 327 may utilize the preference for larger bills and communicate to the point-of-sale 120 that cash change should be paid as one ten dollar bill. Alternatively, the preferences module 310 may contain a preference for smaller (and greater in quantity) banknotes to be paid as cash change. Thus, in the immediate example above, the cash change would be payable as a ten one dollar bills. One of skill in the art will appreciate that many similar preferences may be set relating to the form of cash change to be paid without deviating from the spirit and scope of this disclosure.

The cash module 327 may also make determinations about the amount of money needed to reduce or eliminate the cash change due from a cash-based transaction. The cash module 327 may communicate with the stored value card module 315 to deduct an amount from a stored value card account and apply the amount to the transaction to adjust the cash change due. For example, if the cash change due is $7.17 USD, the cash module 327 may deduct $0.83 USD from a stored value card account and apply it to the transaction such that $8.00 USD cash change is due, which would be payable without resorting to coins.

The cash module 327 may also contain logic to determine the optimal number of banknotes and coin change to increase user satisfaction from a transaction. Users are generally more in favor of accepting banknotes as cash change because banknotes are easily storable while coin change can be cumbersome. Thus, the cash module 327 may make determinations relating to reducing the number of coin cash change paid. Further, if coin cash change is paid, the cash module 327 may make determinations to reduce the number or adjust the type of coins paid as change in the transaction. For instance, the cash module 327 may retrieve and utilize a preference for larger denomination coins versus smaller denomination coins.

A user interface module 329 may be generally operable to present a user interface via the client module 305. Thus, the user interface module 329 may be operable to both display objects and accept user input related to objects. The user interface module 329 may utilize visual means, audio means, haptic means, olfactible means, gustatic means or any other means of interfacing with the user. In one embodiment, the user interface module 329 may utilize 3-D graphics to provide an enhanced user experience. For example, OpenGL or DirectX may be utilized to display advanced graphics.

A secure element module 325 may be generally operable to securely storing information. A secure element is a tamperproof piece of hardware operable to storing sensitive data (e.g., birth date, social security number, bank account number, etc.). The secure element module 325 may be in communication with the secure element. The client module 305 may securely communicate and securely store sensitive information via the secure element module 325. For example, the client module 305 may securely store the stored value card account information in the secure element module 325. Thus, the stored value card module 315 may be in direct communication with the secure element module 325. In one embodiment, the preferences module 310 may communicate with the secure element module 325 to securely store preferences. In another embodiment, the redemption module 322 may be in communication with the secure element module 325 to securely store algorithms, keys, or other cryptosystem-related information.

Turning to FIG. 3B, a server module 330 is depicted. In one embodiment, the server module 330 may be within the server 110, the point-of-sale 120, the computer 115, etc. In another embodiment, the server module 330 may be contained within the wireless device 105, since wireless device processing capabilities and functionalities are constantly increasing. For instance, a small merchant may utilize a smartphone or wireless device similarly to the server 110.

Turning to the specifics of the server module 330, a merchant module 332 may be generally operable to managing the merchants participating in the hybrid m-commerce system 100. In one embodiment, the merchant module 332 may present a web-based interface for merchants to manage accounts, promotions, customers, advertising, etc.

A user module 336 may be generally operable to manage users within the hybrid m-commerce system 100. In one embodiment, the user module 336 may present a web-based interface to allow users to enroll in the hybrid m-commerce system 100. In another embodiment, the user module 336 may connect to a third-party system which hosts user information (e.g., Facebook, Google® Buzz, MySpace, etc.). In one embodiment, the user module 336 may be controlled by a third-party; therefore, the user module 336 may simply be an association to another database, social network, active directory, etc.

A settlement module 340 may be generally operable to conduct money settlements. The settlement module 340 may need to batch transactions such that the settlement transactions occur at one time instead of multiple times throughout the day. In the industry, a “discount rate” is paid by a merchant to a merchant acquirer when electronic payments are processed by a payment card company and/or a financial institution. The discount rate accounts for approximately two percent of the electronic-based transaction costs in the United States.

However, the discount rate is subject to unusually complicated pricing schemas, many of which are beyond the scope of this document. For instance, the discount rate may be $0.25 USD per transaction (a flat fee) and 1.8% of the total transaction price. Thus, a transaction of $100.00 USD would result in a discount rate-based charge of $2.05 ($100.00 USD*1.8%=$1.80 USD+$0.25 USD=$2.05 USD). Stated differently, the merchant would only receive $97.95 from the transaction. Comparatively, a transaction of $0.10 USD would cost $0.2518 USD to process ($0.10 USD*1.8%=$0.0018 USD+$0.25 USD=$0.2518 USD). Thus, a merchant would pay $0.2518 USD to receive $0.10 USD, which would actually cost the merchant more money.

Therefore, the settlement module 340 may be configured to perform “aggregated micro-payment settlement.” First, the settlement module 340 may open a modifiable transaction that allows future changes. Most large merchants use terminal capture settlement or hybrid capture settlement. Terminal capture settlement is a form of settlement where the transactions are stored on the point-of-sale terminal 120. At a predetermined time, the stored transactions are sent in batch for settlement with the bank. Hybrid capture settlement is similar to terminal capture settlement except hybrid capture maintains only a subset of the transaction information and is potentially more efficient in certain scenarios. Using either terminal capture settlement or hybrid capture settlement, the transactions that are posted throughout the day are posted to the same modifiable transaction opened earlier in time. At a later time, the modifiable transaction is closed (e.g., at close of business) and then sent to the bank for settlement. Thus, only one transaction is processed for settlement and the flat fee of $0.25 USD is charged once instead of multiple times throughout the day. One of skill in the art will appreciate that the card companies (e.g., Visa) in the marketplace may limit which parties utilize hybrid capture settlement or terminal capture settlement.

Aggregated micro-payment settlement may advantageously allow for small amounts of money to be transferred using electronic means. As described herein, the change identifier may be for a particularly small amount of money (e.g., $0.22 USD). Thus, the aggregated micro-payment settlement allows for these small amounts of money to be collected and processed under the same interchange fee charge such that the per transaction portion of the interchange fee (the flat fee) does not disproportionately affect the money associated with the change identifier. In one embodiment, the settlement module 340 may be in constant communication with the client module 305 and the point of sale 120 to gather these small amounts of money for settlement in batch.

A user interface module 344 may be generally operable to enable user interaction with the server module 330. Thus, the user interface module 344 may be operable to both display objects and accept user input related to objects. The user interface module 344 may utilize visual means, audio means, haptic means, olfactible means, gustatic means or any other means of interfacing with the user. In one embodiment, the user interface module 344 may utilize 3-D graphics to provide an enhanced user experience. For example, OpenGL or DirectX may be utilized to display advanced graphics.

A stored value card module 334 may be generally operable to manage one or more stored value card accounts. In one embodiment, the stored value card module 334 within the server module 330 is in communication with the stored value card module 315 contained within the client module 305. In one embodiment, the stored value card module 334 may allow transfer of money from a first stored value card account to a second stored value card account. In another embodiment, the stored value card module 334 may allow transfer of money from a first stored value card account to an unbranded stored value card account.

In one embodiment, the stored value card module 334 may be operable to adjust the balance of one or more of the stored value card accounts based on a cash transaction. The stored value card module 334 may deduct an amount from one or more stored value card accounts and apply the amount to the transaction such that the resulting change is reduced or eliminated.

In another embodiment, the stored value card module 334 may be operable to accept a change identifier which may relate to a real-world amount of cash paid to a merchant. The stored value card module 334 may authenticate, accept, and process the change identifier such that the balance of one or more of the stored value card accounts is adjusted.

In yet another embodiment, the stored value card module 334 may be operable to associate a threshold with one or more of the stored value card accounts. If the balance of the stored valued card account goes below the threshold, then a portion or all of the stored value card balance may be transferred to the unbranded stored value card account. In still anther embodiment, if the balance of the unbranded account exceeds a threshold then the balance may be transferred to a stored value card account associated with a merchant.

A redemption module 338 may be generally operable to allow redemption of money represented as a change identifier. As previously stated, the change identifier may relate to a real-world amount of cash paid to a merchant. The redemption module 338 may contain one or more encryption/decryption systems. For instance, the change identifier may be a series of alphanumeric characters received by the server module 330. The redemption module 338 may contain the logic to decrypt the series of alphanumeric characters and ascertain the amount of money being redeemed. In one embodiment, the redemption module 338 may be operable to decipher a barcode image transmitted to the server module 330.

The redemption module 338 may contain logic for parsing emails, SMS messages, MMS messages, tweets, microblog, etc. to extract the change identifier. For example, a preformatted email may be received by the redemption module 338 and processed such that one or more of the stored value card account balances are adjusted. In one embodiment, the redemption module 338 contains pattern matching and/or pattern recognition software to readily detect and acquire the change identifier.

### Operation of the Proposed Solutions

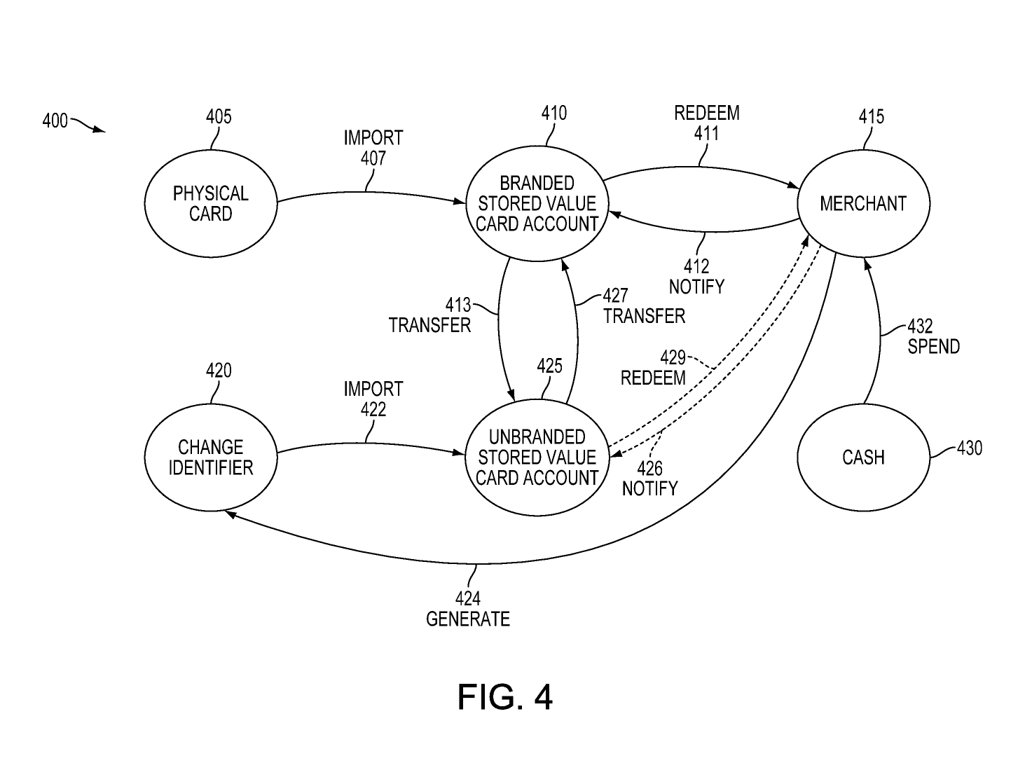

The components described in FIG. 1 through FIG. 3B above shall now be further described in relation to each other. Reference shall be made to the components described above. Turning to FIG. 4, a hybrid m-commerce commerce system 400 is depicted with a number of entities and transitions to illustrate the hybrid m-commerce system 400 in operation. One of skill in the art will understand that the hybrid m-commerce system 400 may be embodied as logic in hardware, software, or combination thereof. In one embodiment, the hybrid m-commerce system 400 is the same or substantially similar to the hybrid m-commerce system 100 from FIG. 1 above.

Turning to the specifics of the hybrid m-commerce system 400, a physical card 405 may be imported 407 into a branded stored value card account 410. The physical card 405 may be constructed from plastic, metallic, paper, or combination thereof. The physical card 405 may have one or more codes imprinted on it. In one embodiment, the physical card 405 may have a “scratch off” layer which exposes additional codes when physically scratched off by a human using a nail, a coin, or other edged object. Examples of a real-world physical card may be a Target® gift card, a Gap® gift card, an Amazon.com® gift card, etc.

The importation 407 of the physical card 405 may occur in a number of manners. In one embodiment, the physical card 405 may be imported using a camera on the wireless device. Computer vision software may then be utilized to analyze and determine which physical cards are present in the photograph captured by the camera. In another embodiment, the account numbers present on the physical card could be manually entered into the wireless device to import 407 the balance associated with the physical card into the branded stored value card account 410. In yet another embodiment, the account numbers of the physical card 405 may be entered into a web-based interface such that the balance is imported 407 into the branded stored value card account 410.

In one embodiment, the importation 407 may cancel the physical card 405 balance such that the physical card 405 may no longer be redeemed at the associated merchant. In another embodiment, the importation 407 may result in a new virtual card number being created for a newly created virtual card. In yet another embodiment, the importation 407 may result in a virtual card which shares the same card number as the physical card. For subsequent redemption, the branded stored value card account 410 may be utilized to access the balance of the physical card 405.

The branded stored value card account 410 may be associated with a merchant i.e. “branded.” Alternatively, an unbranded stored value card account 425 may be associated with the wireless device. In one embodiment, the balance of the branded stored value card account 410 may be transferred 413 to the unbranded stored value card account 425. In another embodiment, the unbranded stored value card account balance may be transferred 427 to the branded stored value card account 410.

As an illustrative example, Dave is an American male in his early 30s. Dave receives a Home Store gift card in the amount of $100.00 USD for his birthday. However, Dave lives in an apartment downtown, and Dave lives alone. He would like to access the Home Store gift card balance, but has no desire to purchase home improvement goods from the Home Store. Using the hybrid m-commerce system 400, Dave could import 407 his Home Store gift card using his wireless device's 105 camera. The imported physical card 405 would then be cancelled and retained in the hybrid m-commerce system 400 as a branded stored value card account balance. Thus, Dave's Home Store branded stored value card account balance would be $100.00 USD. Then, Dave may transfer 413 his Home Store into the unbranded stored value card account 425. Thus, Dave's unbranded stored value card account balance 425 would be $100.00 USD and the Home Store branded stored value card account balance would be $0.00 USD. Next, Dave may transfer 427 a portion of the unbranded stored value card balance into a Bedding Store branded stored value card account because Dave would like to buy a new duvet cover for $38.56 USD (including tax).

The branded stored value card account 410 may be redeemed 411 at a merchant 415. The merchant 415 may then notify 412 the branded stored value card account 410 that the payment was accepted and to reduce the branded stored value card account 410 balance. Similarly, the unbranded stored value card account may be redeemed 429 with the merchant 415 at which point the merchant may notify 426 the unbranded stored value card account 425 to reduce the balance. One key difference between the branded and unbranded stored value card accounts 410, 425 is that the unbranded stored value card account 425 may or may not be accepted by all merchants 415. Hence, the redemption transition 429 and the notification transition 426 are shown in dotted lines. Thus, a user may need to transfer 427 an amount into a branded stored value card account 410 which is associated with the merchant 415 before accessing the amount of money transferred.

Turning back to our example with Dave, if Bedding Store were the merchant 415, then Bedding Store could accept redemption 411 of the branded stored value card account when Dave purchases his duvet cover. Bedding Store, as the merchant 415, may then notify the branded stored value card account 410 to reduce the balance in the amount of the duvet cover $38.56 USD.

Cash 430 may be spent 432 on a transaction at a merchant 415 to pay for goods or services. Cash may or may not generate a cash change amount resulting from the transaction. Turning back to our example, assume Dave paid $50.00 USD cash for the duvet cover instead of using his Bedding Store branded stored value card account 410 balance. Dave would receive $11.44 USD in change, likely in the form of a single ten dollar bill, a single one dollar bill, one quarter, one dime, one nickel and four pennies. Dave is annoyed by cash change because he likes to keep his pockets free to hold his wireless device, wallet, and sports car keys.

In one embodiment, the unbranded stored value card account 425 balance may be used to reduce the amount of cash change resulting from a transaction which employs cash 430. The unbranded stored value card account 425 balance may be redeemed 429 in whole or in part to reduce the amount the customer owes to the merchant 415. Similarly, the branded stored value card account 410 may be redeemed 411 with the merchant 415 to reduce the amount the customer owes to the merchant 415. If the amount is correctly calculated, then the cash change portion may be eliminated.

Turning back to our example with Dave, the duvet cover costs $38.56 USD. Dave has a branded stored value card account 410 balance with Bedding Store in the amount of $100.00 USD. Dave instead pays cash using a fifty dollar bill ($50.00 USD). If Dave were to pay using the fifty dollar bill but redeem 411 a portion of the branded stored value card account balance 410 to reduce the amount owed to a whole dollar amount, then Dave would receive less change. Specifically, if $0.56 USD were redeemed 411 with the merchant 415, then Dave would only owe $38.00 which would result in a $12.00 USD cash change amount, payable as a single ten dollar bill and two one dollar bills. Thus, the coin change portion would be eliminated, resulting in payment of banknotes only.

A change identifier 420 may be generated 424 from a cash 430 transaction with the merchant 415. The change identifier 420 may represent a real-world cash change amount resulting from a transaction, as described herein. Turning back to our example with Dave, assume Dave paid for the duvet cover using $50.00 USD cash. Dave would receive $11.44 USD cash change ($50.00 USD−$38.56 USD=$11.44 USD). However, if a change identifier 420 were generated by the point-of-sale 120 of the merchant 415, then Dave would not receive coins and banknotes, but rather a change identifier 420. The change identifier 420 may then be imported 422 into the unbranded stored value card account 425. For example, Dave may receive a code from the merchant 415 representing the $11.44 USD change owed to him. Dave may then import 422 the change identifier 420 (as represented by the code in this example) by using his wireless device. Thus, the unbranded stored value card account 425 balance may be increased by the change identifier 420 amount of $11.44 USD. As previously discussed, Dave could then transfer 427 an amount of the $11.44 USD in the unbranded stored value card account 425 to the branded stored value card account 410.

In one embodiment, the hybrid m-commerce system 400 may be used in conjunction with SWAGG® created by Outlier, Inc. in Atlanta, Ga. SWAGG allows consumers to exchange gift card balances between participating merchants. A small exchange fee may be imposed when transferring balances between the unbranded account and a branded stored value account. However, many consumers are willing to incur a small fee to transfer the balance from a first merchant to a second, more-desirable merchant. In the example above with Dave, the Bedding Store was more suitable to his needs at the time than the Home Store was.

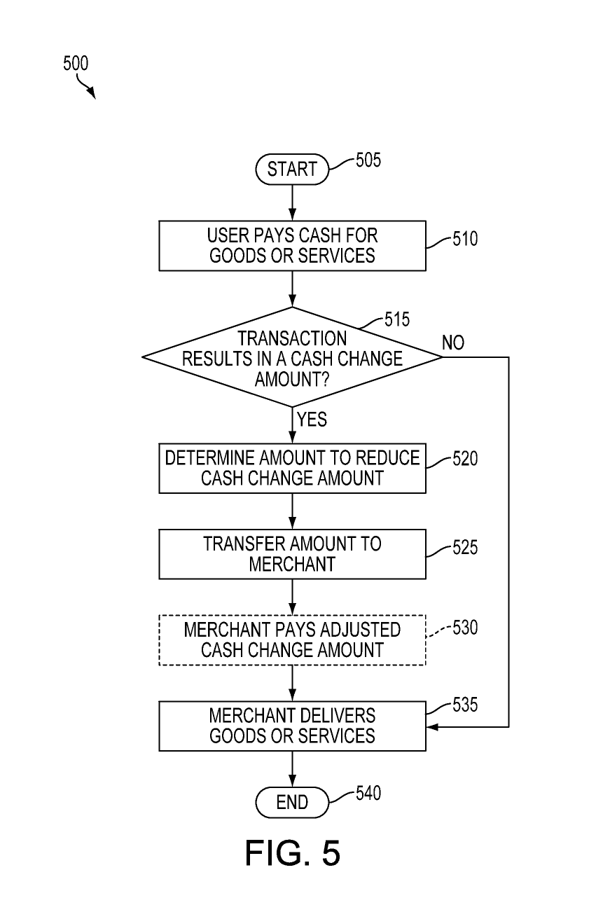

Turning to FIG. 5, a process 500 for adjusting a cash change amount is depicted. At START block 505, the process 500 begins and moves to block 510 where the user pays cash for goods or services.

Before describing the process 500 further, it is understood that in one embodiment the client module 305 from FIG. 3A above is installed in the wireless device 105 or the computer 115 from FIG. 1 above. Further, the server module 330 from FIG. 3B above may be installed at the server 110 from FIG. 1. The client module 305 and the server module 330 may be in communication via the network 130. In addition, the client module 305 or the server module 330 may interact with the point of sale 120, the NFC terminal 124, or the barcode reader 122.

As an illustrative example, Marla may visit a local Clothing Co. store and purchase a pair of blue jeans. Marla then takes the blue jeans to the cash register. The blue jeans cost $43.92 USD including tax. Marla pays using a fifty dollar bill ($50.00 USD).

The process 500 moves to decision block 515 where a determination is made whether the transaction results in a cash change amount. In one embodiment, the determination made in block 515 is contained within the cash module 327 from FIG. 3A above. In another embodiment, the determination at block 515 is made at the point-of-sale 120 operated by the merchant. In another embodiment, the determination at block 515 may be made at the user's wireless device 105. For example, the user may manually enter into the wireless device 105 the item price, the tax, the total, the amount of cash paid, the amount charged to a credit/debit card, etc. If no cash change would result from the transaction then the process 500 proceeds along the NO path to block 535 where the merchant delivers the goods or services to the customer.

In one embodiment, the client module 305 may accept input from the user via the user interface module 329. The merchant module 320 may be utilized to access predetermined information related to the merchant (e.g., local sales tax, prices of items, ability to receive electronic receipts, etc.).

Going back to the block 515, if a determination is made that the a cash change amount would result from the transaction, then the process 500 proceeds to the block 520 where the amount to reduce cash change is determined. Turning back to the example with Marla, the blue jeans cost $43.92 USD and she is paying $50.00 USD. Thus, an amount of $6.08 USD would be due to Marla in the form of cash change. Therefore, the process 500 would proceed to the block 520 in this case. For the sake of illustration, if Marla were to pay exactly $43.92 USD then the process 500 would proceed to block 535 at which point the merchant would simply deliver the goods (i.e. the blue jeans) to Marla.

Turning to block 520, the process 500 determines the amount to reduce the cash change amount. In one embodiment, the cash module 327 may be utilized to make the determination at block 520. In another embodiment, the point-of-sale 120 first determines the amount of cash change due and then communicates that amount to the wireless device 105. In the example with Marla, the point-of-sale 120 at Clothing Co. may communicate to Marla's wireless device 105 that $6.08 USD will be due to her after the transaction. Marla may then interact with the wireless device 105 to acknowledge the amount of cash change to be received, adjust the amount of desired cash change to be received, or eliminate/reduce the amount of cash change to be received. In one embodiment, the cash module 327 may determine that a single five dollar bill, a single dollar bill, a nickel, and three pennies will be received as cash change. The cash module 327 may first attempt to eliminate the coin cash change i.e. the nickel and the three pennies first by transferring to the point-of-sale $0.08 USD. Alternatively, the cash module 327 may try to eliminate the coin cash change portion and some of the banknote portion by transferring $1.08 USD to the point-of-sale terminal 120. Thus, a single five dollar bill would be owed to Marla.

In yet another alternative, the cash module 327 may change the nature of the cash change amount received by transferring more than the cash change amount to be received. For instance, the cash module 327 may transfer $13.92 USD to the point-of-sale 120. If Marla still pays with a fifty dollar bill, then she would receive one twenty dollar bill ($43.92 USD−$13.92 USD−$50.00 USD=−$20.00 USD). Thus, the nature of the cash change receive can be altered by the wireless device 105.

Once the amount to reduce the cash change amount is determined, the process 500 proceeds to the block 525 where the amount is transferred to the merchant. In one embodiment, the cash module 327 directly transfers the amount to the point-of-sale terminal 120 at the merchant's location. In another embodiment, the wireless device 105 communicates with the server 110 to communicate the amount such that the merchant's backend servers are able to reconcile the amount. In yet another embodiment, the wireless device 105 may contain an NFC transceiver and be operable to communicate with the point-of-sale 120 via the NFC terminal 124. In still another embodiment, the wireless device 105 may present a barcode via the user interface module 329 that is operable to being read by the barcode reader 122 at the point-of-sale 120. The process 500 proceeds to the block 530.

At the block 530, the merchant pays an adjusted cash change amount. The block 530 is shown in a dotted line because, in one embodiment, the merchant may pay the amount of cash change owed. For example, the user may decline to adjust, reduce, or eliminate the cash change amount due even though it would be possible given the transaction amount. Turning back to our example with Marla, the cashier at Clothing Co. would receive an indication from the point-of-sale terminal 120 or Marla's wireless device 105 that the amount of cash change has been affected. Thus, the cashier will pay the adjust cash change amount to Marla. The process 500 then proceeds to the block 535.

At block 535, the merchant delivers the goods or services. In one embodiment, the merchant physically hands the goods to the customer along with a paper receipt. In another embodiment, the merchant may send an electronic notification or receipt to the wireless device 105 while contemporaneously handing the customer the goods. The process 500 proceeds to the END block 540 and terminates.

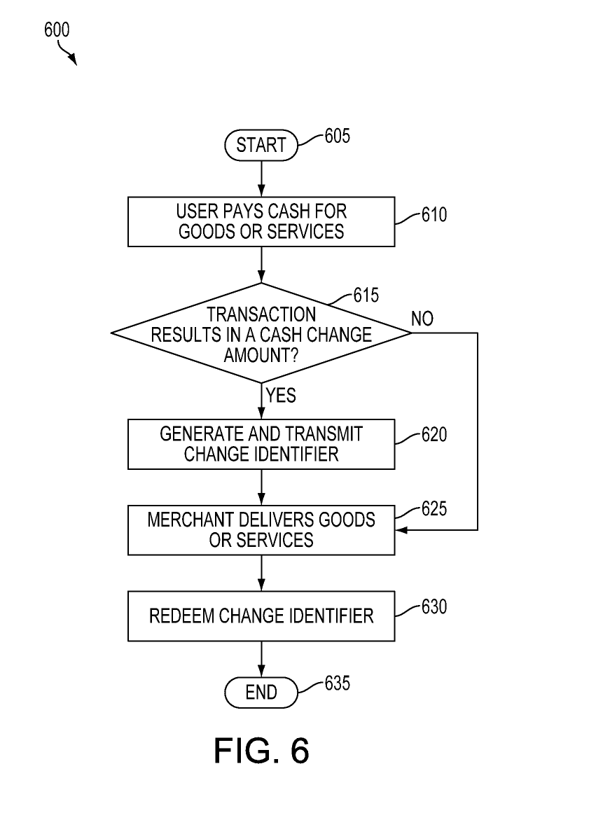

Turning to FIG. 6 a process 600 for receiving a change identifier is depicted. The process 600 begins at the START block 605 and proceeds to the block 610 where the user pays cash for goods or services. The paying of cash in the block 610 may be similar to the paying of cash in the block 510 from FIG. 5 above. Turning back to our example with Marla buying jeans from Clothing Co. in FIG. 5 above, assume that Marla is again buying the same pair of blue jeans for $43.92 USD. Marla again pays fifty dollars cash in the form of a single fifty dollar bill. The process 600 proceeds to the decision block 615.

At the decision block 615, the process 600 determines whether the transaction results in a cash change amount. The decision block 615 may be similar to the decision block 515 described above in FIG. 5. If the determination does not result in a cash change amount, then the process 600 proceeds along the NO branch to the block 625 where the merchant delivers the goods or services. Going back to the determination block 615, if the transaction will result in a cash change amount then the process 600 proceeds along the YES branch to the block 620. Turning back to the example with Marla and the blue jeans, the transaction will result in a cash change amount being due because $50.00 USD minus $43.92 USD results in $6.08 USD cash change. Thus, a cash change amount would be due in Marla's scenario.

At the block 620, the process 600 generates and transmits a change identifier. As previously stated, cash change is undesirable to many customers. The change identifier may eliminate the need to use cash change in many circumstances. For instance, the change identifier may eliminate cash change in Marla's transactions for the blue jeans. The change identifier may be a code, a barcode, a password, a key, an alphanumeric string, etc. which is associated with amount of cash change resulting from a transaction. The change identifier may then be redeemed at a later time for a cash balance amount.

In one embodiment, the point-of-sale terminal 120 may generate a change identifier. The point-of-sale 120 may print the change identifier as a code on a paper receipt which is given to the customer at the conclusion of the transaction. The point-of-sale 120 may alternatively transmit the change identifier using NFC to the wireless device 105. In another embodiment, the server 110 may generate the change identifier and directly communicate the change identifier to the wireless device 105 through the network 130 or via the point-of-sale terminal 120.

In one embodiment, the change identifier is communicated in a pre-formatted message sent via email, SMS, MMS, tweet, microblog, etc. The client module 305 may be configured to decipher and redeem the change identifier such that the money associated with the change identifier is applied to a stored value card account. For instance, the money associated with the change identifier may be applied automatically to the unbranded account.

In another embodiment, the customer may have a user identification (“user ID”) associated with the hybrid m-commerce system 100, 400. The user ID may be verbally or electronically communicated to the merchant at transaction time such that the change identifier is automatically associated with the client module 305 belonging to the customer. Further, the change identifier may be then substantially automatically associated with a stored value card account associated with the merchant issuing the change identifier. As such, the merchant may drive customer loyalty because the customer has now received a stored value card balance which may be redeemed at the merchant a later time. And, unlike cash, the customer may need to return to the merchant to utilize the money. The tradeoff being that the customer did not have to carry cash change with his or her person.

Turning back to the example with Marla, after paying the fifty dollar cash amount, Marla is entitled to $6.08 USD cash change. Using the process 600, the Clothing Co. point-of-sale terminal 120 may then print out a paper receipt upon which a change identifier is printed. In one embodiment, a user-friendly message and/or instructions may appear substantially near the change identifier. Marla may then receive no cash change because the change identifier accounts for the cash change she is owed. Marla will then need to redeem the change identifier to receive the monetary amount of money still owed. The process 600 proceeds to the block 625 where the merchant delivers the goods or services.

At the block 625, the merchant delivers the goods or services. The delivery of goods or services is similar to the block 535 described above in FIG. 5. In one embodiment, the merchant may deliver the change identifier along with the goods being purchased. The process 600 proceeds to the block 630 where the change identifier may be redeemed.

At the block 630, the change identifier may be redeemed. In one embodiment, the redemption of the change identifier may be performed on the wireless device 105. For instance, the customer may read the change identifier from a paper receipt and manually input the change identifier into the wireless device 105. In one embodiment, the redemption module 322 communicates with the server module's 330 redemption module 338 to validate and process the change identifier. For instance, the server module may utilize a number of cryptosystems to ascertain that the amount of money associated with the change identifier is not fraudulent. The redemption module 338 may then communicate with the stored value card module 334 to indicate an increase in a stored value card account related to the change identifier. In one embodiment, the amount of money redeemed via a change identifier is automatically added to the unbranded stored value card account.

In another embodiment, the change identifier money is applied to a stored value card account associated with the merchant, which originally issued the change identifier. As previously stated, having the change identifier money automatically applied to the issuing merchant may drive customer loyalty because they will build up a balance over time that may drive repeat visits. For instance, the customer may be more inclined to return to Coffee Co. knowing that they already have a balance of $7.98 USD as a result of a previous cash transaction which resulted in a change identifier.

Turning back to the example with Marla, assume she received a change identifier embodied as an alphanumeric code “G8SP223” on her Clothing Co. receipt. If Marla enters the code “G8SP223” into her client module 305, then the client module 305 may indicate that the redemption module 322 is processing her request. Once processed and validated by the client module 305 and the server module 330, an amount of money may associated with one or more of Marla's stored value card accounts. In one embodiment, the amount of money associated with the change identifier is applied to her unbranded stored value card account. Marla can then transfer the unbranded stored value card account balance to a branded stored value card account. For instance, she could transfer the $6.08 USD to an Organic Food Shop stored value card account, where she can purchase food for dinner. In sum, Marla was able to take a fifty dollar bill, purchase a pair of blue jeans, avoid receiving cash, and buy dinner at a different store using only her wireless device 105.

One of skill in the art will appreciate that a significant time delay may occur between the block 625 and the block 630. Stated differently, the issuing of the change identifier may occur at a significantly earlier time than the subsequent redemption of the change identifier. Some users may simply pile the paper-based change identifiers up in their change jars, glove compartments, wallets, etc. until they decide to redeem them at once. Similar to gift cards, merchants may monetize this delay in redemption. The process 600 then proceeds to the END block 635 and terminates.

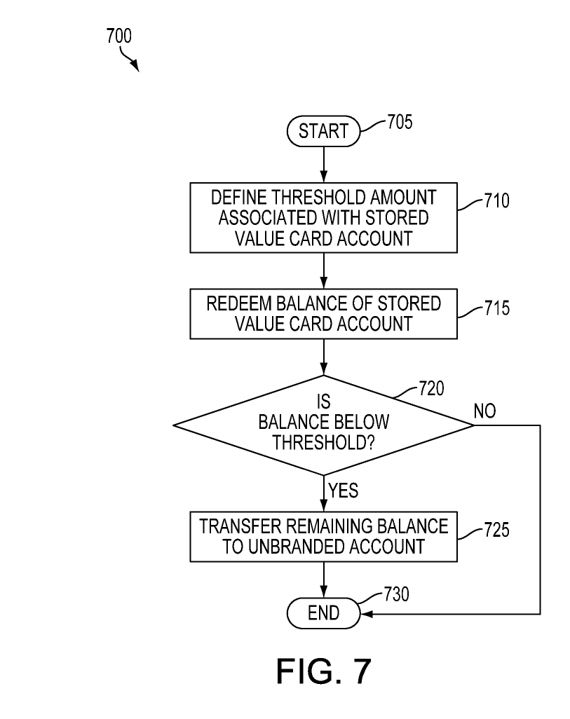

Turning to FIG. 7, a process 700 for transferring a balance to a stored value card account is depicted. The process begins at the START block 705 and moves to the block 710 where a threshold amount is associated with a stored value card account. The threshold amount is a user-defined or merchant-defined amount of money associated with a stored value card account and the stored value card account's balance. If the threshold amount is exceeded, then the balance of the stored value card account may be adjusted or transferred. For example, the threshold amount may be $1.00 USD, $10.00 USD, $100.00 USD or some other amount.

In one embodiment, the preference module 310 may store and manage the threshold amount. For instance, the user interface module 329 may present a series of menus, widgets, etc. to allow user interaction to set, adjust, or remove the threshold amount. In one embodiment, the threshold amount may be associated with a plurality of stored value card accounts held within the stored value card module 315. In another embodiment, a unique threshold amount may be associated with each of the stored value card accounts managed by the stored value card module 315. Turning back to the illustrative example of Marla buying blue jeans at Clothing Co., Marla may use her wireless device 105 to manage a plurality stored value card accounts from various merchants. Specifically, her stored valued card accounts may be with Clothing Co., Home Store, Shoes, Inc., and Coffee Co., each of which may have a balance. Further, Marla has associated each stored value card account with a threshold amount. If the threshold amount is exceeded, then the balance will be transferred to the unbranded account. Table 1 below depicts the various merchants, balances, and threshold amounts.

TABLE 1

| Merchant | Balance (in USD) | Threshold Amount |
|---|---|---|
| Clothing Co. | $44.00 | $1.00 |
| Organic Food Store | $25.00 | $0.50 |
| Electronic, Inc. | $250.00 | Not defined |
| Coffee Co. | $100.00 | $25.00 |
| Unbranded account | $32.35 | Not defined |

As shown above in Table 1, the balances are stored value card balances that are redeemable for goods or services at the merchant. The threshold amounts are shown as U.S. dollar amounts but are also shown as “not defined.” In some situations, the user may not wish to define a threshold amount. For instance, Clothing Co. is a women's clothing retailer and Marla likes to shop for business suits there. As such, she desires to always maintain a balance in her Clothing Co. stored value card account to remind her to shop there, even if the balance is a small, fractional dollar amount.

Note that the threshold amounts may differ. In this example, the threshold amounts relate somewhat to the goods/services offered by the merchant. Organic Food Store is a large grocery store and as such the threshold amount is $0.50 USD because Organic Food Store sells many low-priced goods (e.g., juice, fruit, bread, etc.). Comparatively, the threshold amount is higher for Electronic, Inc. a large electronics store. Having a balance less than $25.00 may not be interesting to Marla because she only buys items that cost hundreds or thousands of dollars (e.g., stereo systems, LCD televisions, etc.). One of skill in the art will appreciate that the threshold amounts may be any value and the value need not coincide with the goods/services offered by the merchant.

The threshold amounts the unbranded account may have a balance. As shown in Table 1, the unbranded account does not have a threshold amount. However, it would be possible to have a threshold amount associated the unbranded account. For instance, a threshold amount of $10.00 USD may be associated with the unbranded account such that when the unbranded account balance is below (or above) the amount, then a predetermined action occurs. For instance, if the unbranded account has a threshold amount of $100.00 USD, then the stored value card module 315 may transfer the entire unbranded account balance to Electronic, Inc. stored value card account such that the user may purchase the new smartphone she has been wanting for the past six months.

One of skill in the art will appreciate that in many examples herein the threshold amount is described as being reached when the balance goes below the threshold amount. However, the threshold amount may be reached when the balance is exactly the threshold amount. Further, the threshold amount may be reached when the balance exceeds the threshold amount.

Turning back to the process 700 depicted in FIG. 7, once the threshold amount is defined, the process 700 proceeds to the block 715. At the block 715, the user of the wireless device 105 may redeem the balance of one of the stored value card accounts at a merchant. In one embodiment, communication may occur between the client module 305 and the server module 330. For instance, the stored value card module 315 within the client module 305 may communicate with stored value card module 334 within the server module 330. The user may interact with any number of menus, icons, widgets, screens etc. as presented by the user interface module 329.

In another embodiment, the stored value card module 315 may be engaged to communicate with the point-of-sale terminal 120 such that an amount is transferred to the merchant via the point-of-sale terminal 120 (e.g., via the NFC terminal 124 or the barcode reader 122). In one embodiment, the point-of-sale terminal 120 may communicate with the server module 330. In another embodiment, the point-of-sale terminal 120 may contain the server module 330 such that the communication need not traverse the network 130.

Turning to our illustrative example with Marla buying blue jeans, Marla may present her wireless device at Clothing Co. to pay for blue jeans priced at $43.92 USD. Marla uses her wireless device 105 to pay for the transaction. Marla selects her Clothing Co. stored value card account to pay. The client module 305 presents a 2-D barcode which is operable to scanning by the barcode reader 122 at the point-of-sale 120. The merchant scans the 2-D barcode from the screen of the wireless device 105. The merchant's point-of-sale 120 communicates with the server module 330 to authenticate the payment form. The server module 330 determines that $44.00 USD is associated with Marla's Clothing Co. stored value card account balance. The point-of-sale 120 indicates to the merchant that the transaction is authorized and prints a paper receipt. The cashier gives the paper receipt to Marla along with the blue jeans. The process 700 then proceeds to decision block 720.

At the decision block 720, the stored value card module 315 checks the balance of the stored value card account used in the redemption at the block 715. If the balance is not below the threshold amount, then the process proceeds along the NO branch to the END block 730 at which point the process 700 terminates. If the balance is below the threshold amount stored, then the process 700 proceeds along the YES branch to the block 725. The preferences module 310 and the stored value card module 315 may be utilized at the block 720 to determine if the balance is below, equal to or above a threshold amount. Further, the client module 305 may communicate with the server module 330 to make the determination at the block 720.

In Marla's example, the remaining balance of her Clothing Co. stored value card account would be $0.08 USD after the transaction ($44.00 USD−$43.92 USD=$0.08 USD). As such, the process 700 would move to the block 725 in Marla's example.

At the block 725, the remaining balance is transferred to the unbranded stored value card account. In one embodiment, the stored value card module 315 manages the stored value card accounts and any transfers among the plurality of stored value card accounts. Turning back to the example with Marla, since the balance of her Target stored value card account is $0.08 USD, the process 700 may transfer the $0.08 USD to the unbranded account. Therefore, the unbranded account will go from $32.35 USD to $32.43 USD. Note Marla may continue to increase the balance of the unbranded account until she decides to associate it with a stored value card account belonging to a merchant. For instance, Marla may wait until the unbranded stored value card account reaches $100.00 or more until she associates it with Electronics, Inc. to buy the smartphone she did not get for her birthday. FIG. 4 above describes in further detail process of transferring balances between the stored value card accounts. The process then proceeds to the END block 730 and terminates.

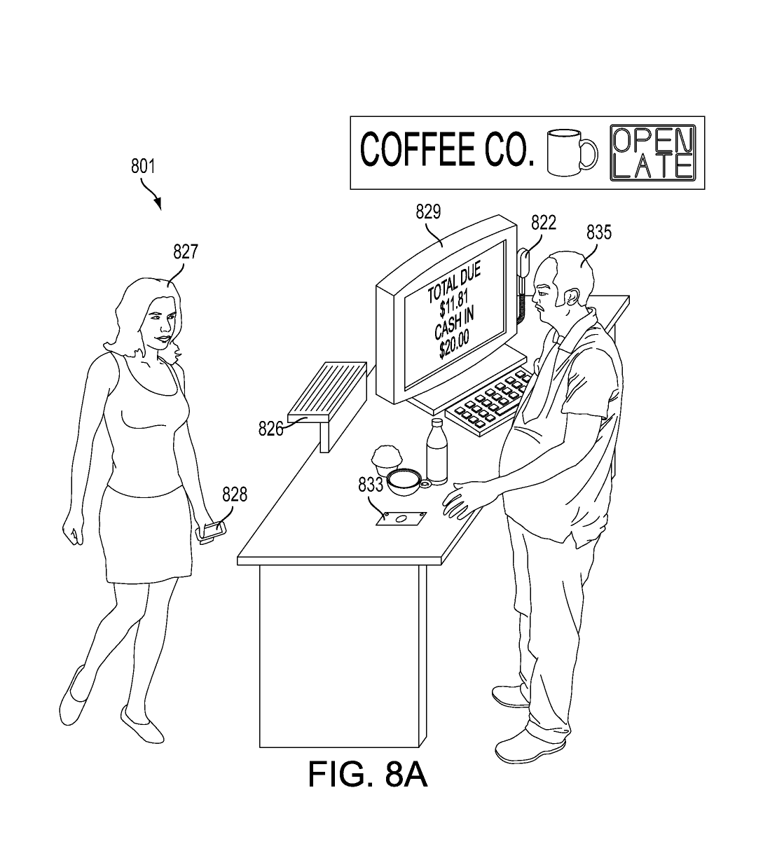

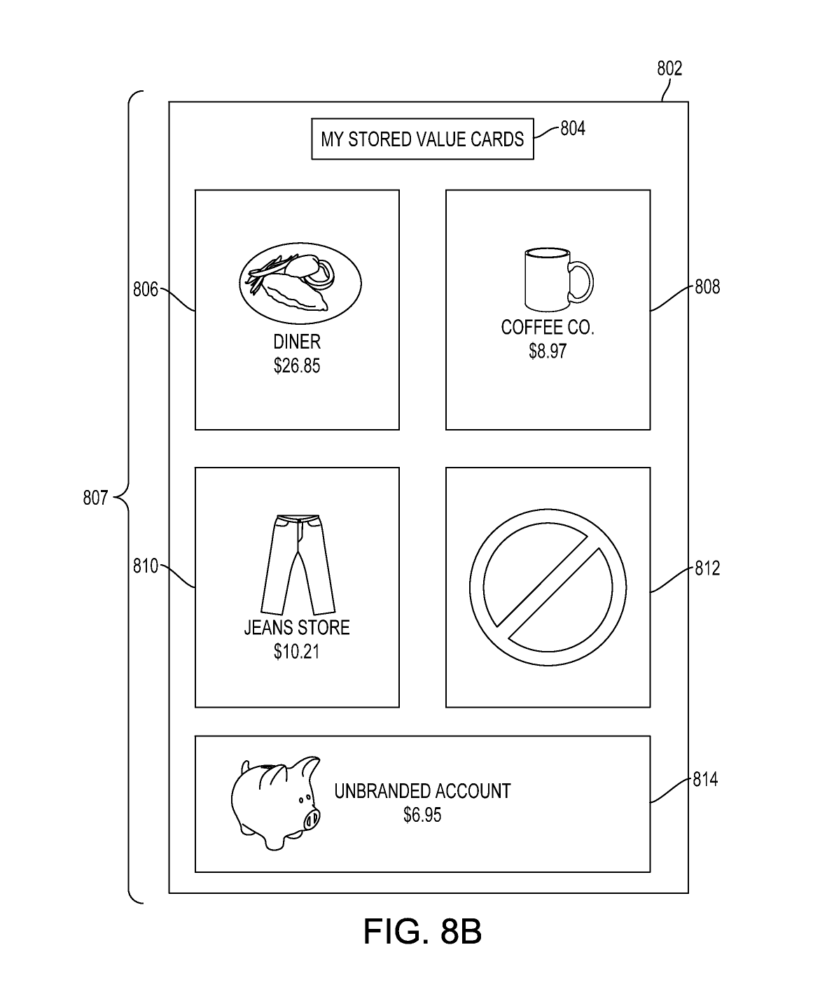

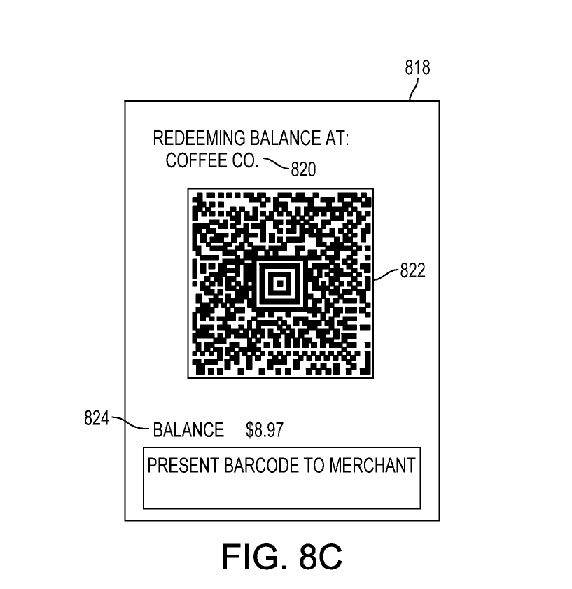

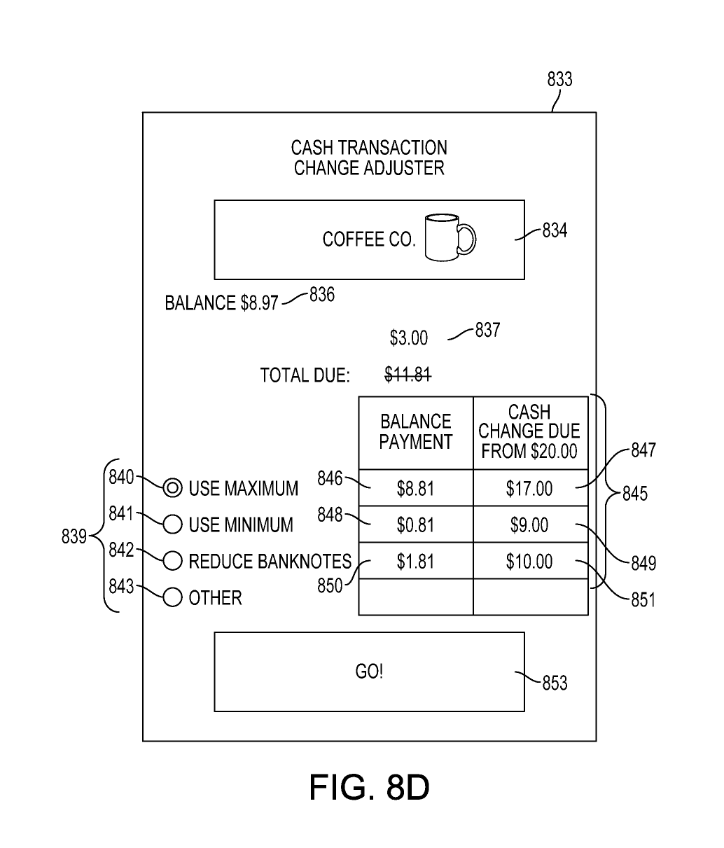

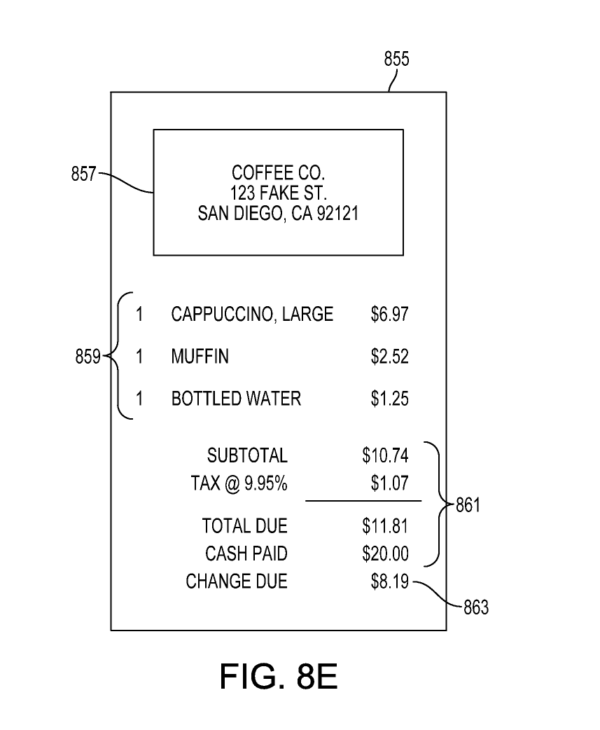

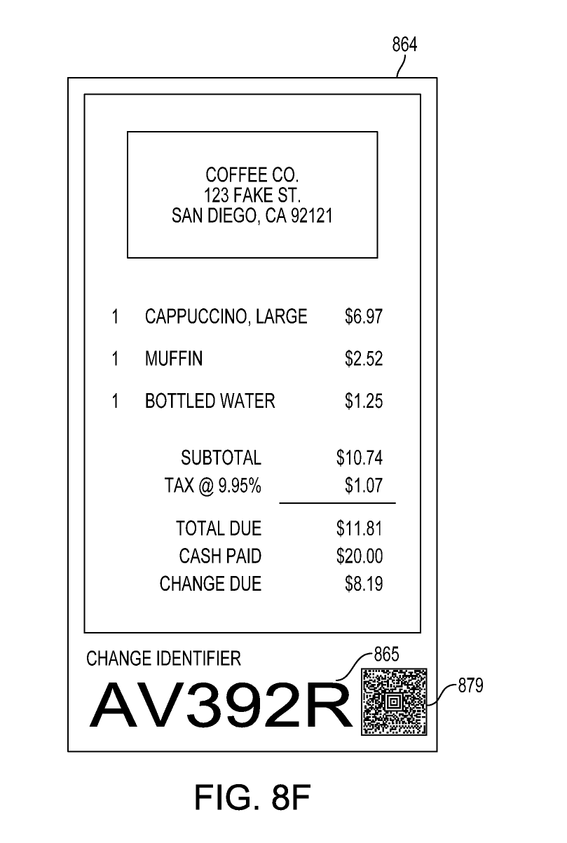

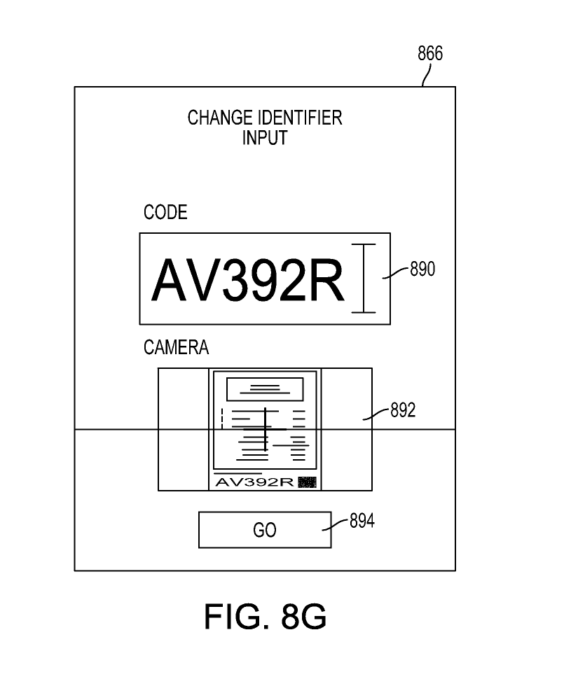

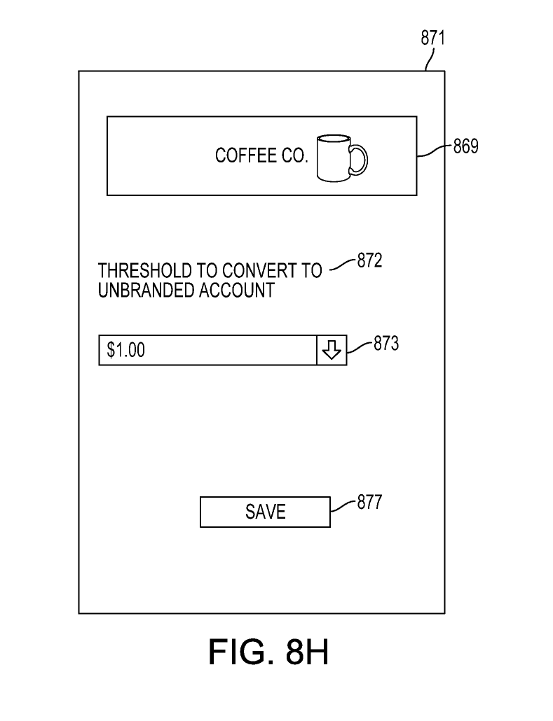

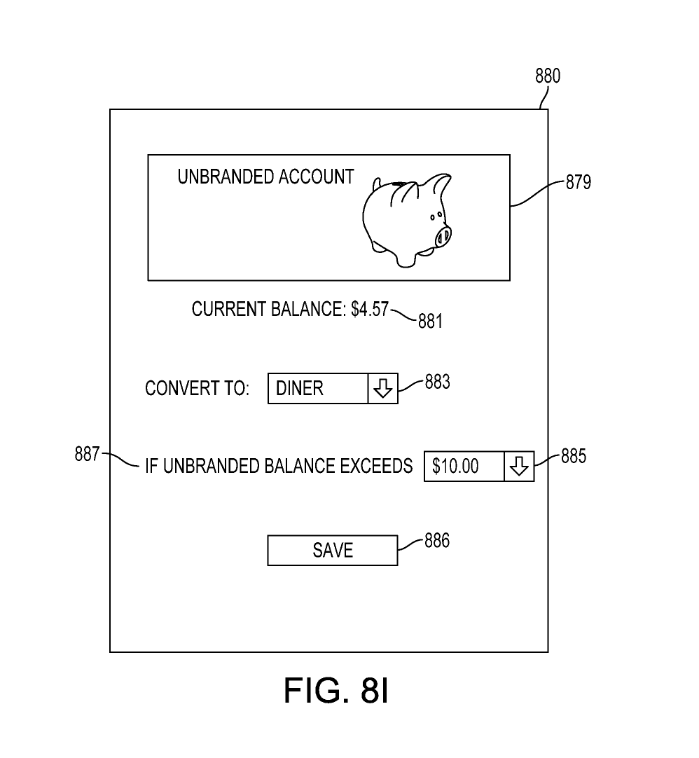

Turning to FIG. 8A through FIG. 8I, a series of screenshots and use cases of the hybrid m-commerce system 100, 400 in use are depicted. The series of screenshots and use cases may further illustrate the processes 500, 600, 700 depicted in FIG. 5, FIG. 6, and FIG. 7 respectively.

FIG. 8A depicts a scene 801 of a user 827 paying for coffee using the hybrid m-commerce system 100, 400. The scene 801 shall serve as a context to describe the rest of the figures within the series FIG. 8A through FIG. 8I. However, the concepts presented herein shall be considered illustrative and not limited to the hypothetical facts described. The user 827 may hold the wireless device 828. In one embodiment, the wireless device 828 is similar to the wireless device 105 described above. Further, the wireless device 828 may have a client module 305 installed.

A point-of-sale terminal 829 may be operable to accept and process payments by the user 827. The point-of-sale terminal 829 may have a handheld barcode scanner 822 and an NFC terminal 826. Note the point-of-sale terminal 829 may be similar to the point-of-sale terminal 120 depicted in FIG. 1. Further, the barcode scanner 822 may be similar to the barcode reader 122 depicted in FIG. 1. Additionally, the NFC terminal 826 may be similar to the NFC terminal 124 depicted in FIG. 1.

The point-of-sale terminal 829 may be operated by a cashier 835. The cashier 835 may use the barcode scanner 822 to scan items for sale. Further, the cashier 835 may utilize the barcode scanner 822 to scan barcode images presented on the wireless device 828. One of skill in the art will appreciate that some wireless devices may not be equipped with NFC and may require scanning by the point-of-sale 829.

A banknote 833 may be used to complete the transaction along with the wireless device 828. For instance, the user 827 may pay with the banknote 833 and desire to adjust the cash change due using the wireless device 828.

As an illustrative example, assume Alice is a young woman in her mid-20s who works as a bartender at a popular night club. She uses her wireless device 105 to manage many of her stored value card balances. Alice finds that using her wireless device 105 in lieu of the plastic cards to be liberating because she no longer needs to keep several plastic cards in her wallet or purse at the same time. Further, having the stored value cards in an electronic format connected to the server module 330 allows her to transfer balances among the various stored value card account accounts such that she never has to worry about losing some of the stored value card balance.

However, like many people, Alice still relies on cash for many transactions because she receives cash tips from her customers. Ideally, Alice would like to keep her cash in her wireless device 105 as well, but that would require depositing the cash at a bank or automatic teller machine, which is yet another interruption to her busy lifestyle. Instead, she simply spends cash as often as possible.

FIG. 8B depicts a screenshot 802 showing a graphical user interface for managing stored value card accounts. At the top of the screen is a user-friendly menu bar 804 stating “My Stored Value Cards.” A plurality of buttons 807 may be present, each of which associated with a stored value card account. A Diner button 806 may be present and show a balance of $26.85 USD. A Coffee Co. button 808 may be present showing a balance of $4.97 USD. A Jeans Store button 810 may be present showing a balance of $10.21 USD. An unused button 812 may be present since the user only has three stored value card accounts, thus the user may add additional stored value card accounts to the screenshot 802. In one embodiment, pressing the unused button 812 may invoke a process for transferring an amount from the unbranded account to a newly-created stored value card account as described above in FIG. 4. An unbranded account button 814 may be present and show a balance of $6.95 USD.

Turning to FIG. 8C, a screenshot 818 is depicted. The screenshot 818 generally shows how the display of the wireless device 105 would look if the user prepared the client module 305 to pay for a transaction involving cash. In one embodiment, the process 500 from FIG. 5 above may be invoked.

The name of the merchant may be identified by a label 820. A 2-D barcode 822 may be displayed on the screen such that the merchant may scan the display of the wireless device 105 using a barcode reader 122 at the point-of-sale terminal 120. A balance 824 of the stored value card account may be displayed on the wireless device 105 as well.

One of skill in the art will appreciate that prior to the screenshot 818, there may be an authentication stage requiring a user name, a password, a personal identification number (“PIN”), a private key, a public key, etc. Further, there may be an authorization stage which requires the user to authorize the wireless device 105 to be used in the transaction (e.g., a “Are you sure you would like to use the $4.97 USD balance at Coffee Co.?”).

Going back to the example with Alice, she has a wallet full of banknotes, mostly twenty dollar bills. She had a great night bartending and would like to spend the banknotes before using her stored value card account balances because it is risky carrying so much cash. Alice walks into Coffee Co. and orders a large cappuccino, a muffin, and a bottled water. She presses the Coffee Co. button 808 from FIG. 8A and invokes the screenshot 818 shown in FIG. 8B. The stored value card module 315 determines the available balance and presents the balance 824 amount as $4.97 USD. The merchant module 320 may determine, using a database, that the point-of-sale 120 is not equipped with an NFC terminal 124 and thus relies on presenting a 2-D barcode 822 operable to being scanned by the point-of-sale terminal 120. Alice's order is placed on the counter and a cashier asks for payment.

Turning to FIG. 8D, a screenshot 833 is depicted. The user 827 may indicate to the cashier 835 that a portion of the transaction will be paid using the banknote 833 while another portion of the transaction is paid using one or more stored value card accounts. The user interface module 329 may present a number of options, menus, radio buttons, numbers, etc. such that the user 827 has control over how much of the stored value card account's balance is used in the transaction.

In one embodiment, the point-of-sale terminal 829 may communicate with the wireless device 828 using the network 130 from FIG. 1. Alternatively, the wireless device 828 and the point-of-sale terminal 829 may communicate using NFC.

A banner 834 may generally show the name of the merchant. In one embodiment, the merchant module 320 may be utilized to present merchant-related information. A balance 836 may be shown on the screen of the wireless device 828. In this example, the balance is $8.97 USD.

A total due 837 may be shown. In this example, the total due for the transaction is $11.81 USD. Note that the total due 837 may be struck out and adjusted based on how the user 827 opts to pay for at least a portion of the transaction using the wireless device 828. As the user changes options on the screen of the wireless device 828, the total due 837 may dynamically change to provide an indication in real-time to the user 827.

A plurality of radio buttons 839 may be presented to allow the user 827 to select the manner in which the client module 305 will calculate the amount to adjust the cash change amount. Each of the plurality of radio buttons 839 corresponds to a row within the plurality of balances and cash change amounts 845. A radio button 840 corresponds to using the maximum amount of the stored value card account. Note that the “maximum” amount in this example is the maximum amount which will not yield a cash change portion payable in coin change. Note that many users find change irritating but that same time would like to reduce the balance of stored value card accounts. Thus, an amount 846 of $8.81 USD is payable from the stored value card account in this example. The amount $8.81 USD leaves $3.00 USD due to the merchant. Thus, if the banknote 833 is a twenty dollar bill, then an amount 847 of $17.00 USD would be payable as cash change to the user 827. The $17.00 USD would likely be paid as one ten dollar bill, one five dollar bill, and two one dollar bills.

A radio button 841 corresponding to using a minimum amount of the stored value card account balance may be shown. The “minimum” amount in this case means the minimum amount necessary to eliminate the coin change portion of any cash change due from the transaction. Note some users may want to avoid cash change but do so in a manner that preserves the balances of the stored value card accounts. Thus, an amount 848 of $0.81 is shown on the screen of the wireless device 828. The total due would be $11.00 USD if the amount 848 of $0.81 were paid from the stored value card account associated with the merchant. Note this would lead to an amount 849 of $9.00 USD cash change being due to the user 827, which would likely be payable as one five dollar bill and four one dollar bills.

A radio button 842 corresponding to reducing the number of banknotes may be presented on the screen of the wireless device 828. The reducing banknotes button may be used to calculate the fewest number of banknotes possible from a cash transaction. An amount 850 of $1.81 USD would reduce the balance of the transaction from being $11.81 USD to $10.00 USD. Thus, an amount 851 of $10.00 USD would be payable as cash change. One of skill in the art will appreciate that such a reduction of banknote change may be ideal for many users because receiving many banknotes may be just as, if not more, irritating than receiving coin change.

A radio button 843 corresponding to another amount may be present to allow a user-defined or merchant-defined amount to be used to adjust the cash change amount due. In such case, the wireless device 828 may present a user-editable field allowing numeric entry.

In one embodiment, the selection of one of the plurality of radio buttons 839 invokes the cash module 327 within the client module 305 such that the calculations are done within the wireless device 828. The total due 837 may be updated in real-time as the results of the cash module's 327 calculations are returned and communicated to the user interface module 329.

A go button 853 may be presented to allow the user to authorize the transaction using the parameters shown in the screenshot 835. The go button 853 may be illuminated only after the user 827 selects one of the plurality of radio buttons 839. An optional pop-up menu asking for confirmation may be displayed (not shown).

Going back to the example with Alice, the cashier was last waiting for payment for the large cappuccino, the muffin, and the bottled water. Alice may place the twenty dollar banknote 833 on the cashier's 835 table. She may verbally indicate that she would like to pay using the wireless device 828 and the banknote 833. The cashier 835 may prepare the point-of-sale terminal 829 for acceptance of the amount to adjust the cash change amount from the wireless device 828. Alice's wireless device 828 is not equipped with NFC, so the cashier 835 prepares to scan the wireless device 828 using the barcode scanner 822. The point-of-sale terminal 829 communicates to the server module 330, which notifies the client module 305 within the wireless device 828 that the merchant is ready for payment.

Alice may then be presented with the screenshot 835. Alice selects the first radio button 840 to use the maximum amount of the stored value card account balance. The cashier 835 takes the banknote 833 and places the banknote 833 behind the point-of-sale terminal 829. Alice's wireless device 828 presents an acknowledgment to her. Substantially simultaneously, the point-of-sale 829 indicates to the cashier 835 the amount of cash change due as adjusted by the wireless device 828 and the hybrid m-commerce system 100, 400. The cashier then pays Alice $17.00 USD in cash change.

Turning to a slightly modified scenario using the same actors from FIG. 8A, assume Alice did not have a stored value card account associated with the merchant Coffee Co. And, assume Alice walked into Coffee Co. simply with a twenty dollar bill and her wireless device 828. Further, assume she has never visited Coffee Co. before. With this modified scenario in mind, turn to FIG. 8E depicting a receipt 855. If the user 827 did not have a stored value card account associated with the merchant and paid cash, then the receipt 855 would likely be handed to the user 827 substantially simultaneously with the goods or services being delivered.

The receipt 855 may have the name 857 of the merchant depicted across the top of the receipt 855. The goods sold 859 may be enumerated along with the amount. A plurality of calculated values 861 may be shown, which includes a subtotal amount, a tax amount, a total due amount, and a cash paid amount. A change due amount 863 may be shown as the last item in the receipt 955.

One of skill in the art will appreciate that the receipt 955 may be electronic or paper. For instance, the receipt 955 may be electronically communicated to the wireless device 828 using NFC and stored in memory. In one embodiment, the receipt 955 may be stored within the secure element module 325.

Turning to FIG. 8F, a receipt 864 may be similarly presented to the user 827. In many respects, the receipt 864 is similar to the receipt 955 from FIG. 8E. However, a change identifier code 865 may be presented at the bottom of the receipt 864. As shown, the change identifier may be an alphanumeric code “AV392R.” A change identifier barcode 879 may be presented as well for capture by a barcode reader or a camera using computer recognition software. In one embodiment, the receipt 864 may be utilized as part of the process 600 depicted in FIG. 6 above.

Note that the change identifier may be communicated to the wireless device 828 electronically. For instance, an SMS message may be sent to the wireless device 828 based upon a telephone phone number given to the merchant during the checkout process. In another example, the user 827 may communicate a user ID to the merchant such that the change identifier is virtually applied to one or more stored value card accounts belonging to the user 827.

Going back to the modified example with Alice, assuming she paid using a twenty dollar banknote, then she would be entitled to $8.19 USD cash change. Instead of receiving the cash change, Alice may receive a receipt 864 containing the change identifier in one or more formats. The change identifier may be presented as a change identifier code 865, a change identifier barcode 879, or combination thereof. Note that Alice would not receive any banknotes, because the change identifier serves as a record of the transaction's cash change amount. Alice may later redeem the change identifier for the monetary equivalent of the cash change due.

Turning to FIG. 8G, a screenshot 866 depicts the inputting of a change identifier into the wireless device 828. A text entry field 890 may be operable to user input. The text entry field 890 may be auto-completed after a communication from the point-of-sale terminal 829. For instance, the point-of-sale terminal 829 may communicate the change identifier directly to the wireless device 828 at substantially the same time as the paper or electronic receipt is given to the user 827.

In one embodiment, a camera on the wireless device 828 may be utilized to capture the change identifier if the change identifier is printed on a paper receipt. For instance, the change identifier may be embodied as the change identifier code 865 or the change identifier barcode 879 from FIG. 8F above. In another embodiment, the change identifier may be presented on a computer screen connected to the point-of-sale. Further, the user 827 may utilize the camera input field 892 to capture directly from the computer screen. Thus, a camera input field 892 may be generally operable to assist the user in capture and acquisition of the change identifier.

Once the change identifier has been entered into the wireless device 828, a go button 894 may be selected. Once the go button 894 is selected the change identifier may be redeemed via the redemption module 322 within the client module 305. Further, the redemption module 322 may communicate to the server module's 330 redemption module 338 as well in order to authenticate the change identifier. Once authenticated, the amount of money associated with the change identifier may be added to one or more stored value card accounts via the stored value card module 315.

Going back to the example with Alice, remember that in the modified example, she has no stored value card account with Coffee Co. As such, when she inputs the change identifier into the wireless device 828 the amount of money associated with the change identifier may be added to the unbranded stored value card account or a newly created stored value card account associated with the merchant Coffee Co. Thus, paying cash while using the hybrid m-commerce system 100, 400 provides an opportunity to invite new users to move money into stored value card accounts. Further, on subsequent transactions, Alice can transfer the money previously associated with the change identifier to one or more stored value card accounts.

Turning to FIG. 8H, a screenshot 871 depicting the setting of a threshold amount is depicted. In one embodiment, the process 700 from FIG. 7 above may be invoked. A label 869 identifies the currently selected merchant. General instructions 872 may be present to assist the user. A pull-down menu 873 may be present to allow the user to select a threshold amount from a predetermined plurality of threshold amounts. In one embodiment, the threshold amount may be manually entered via a free-text field (not shown). Once the user has determined the threshold amount, a save button 877 may be selected thus saving the threshold amount. In one embodiment, the threshold amount is saved within the preferences module 310.

In the example shown in FIG. 8H, the threshold amount is reached when the Coffee Co. stored value card account balance goes below $1.00. Turning back to our example with Alice, if Alice continues to use her Coffee Co. stored value card account to reduce the cash change amount of cash transactions, then eventually the Coffee Co. stored value card account balance may be too low to adjust the change amount. Thus, she is better served if that amount is automatically transferred to the unbranded account where it can later be used (potentially with another merchant). In one embodiment, she could utilize the hybrid m-commerce system 400 described in FIG. 4 above to transfer money between stored value card accounts.

Turning to FIG. 8I, a screenshot 880 depicts automatically transferring money from the unbranded account to a selected stored value card account upon reaching the threshold amount. A label 879 may display the unbranded account prominently to provide user guidance. A balance 881 may be shown indicating to the user the current balance of the unbranded stored value card account. A pull-down menu 883 may be present containing a plurality of merchant names currently associated with the hybrid m-commerce system 100, 400. In one embodiment, a free-text field (not shown) may be shown to allow the user to manually enter and look up a merchant not otherwise listed. Instructions 887 may be present to guide the user through the process of defining a threshold amount. Yet another pull-down menu 885 may be shown to allow the user to select from a plurality of threshold amounts. A save button 886 may be displayed to allow the user to save the threshold amount.

In one embodiment, the threshold amount is stored in the preferences module 310 within the client module 305. Note that one or more threshold amounts may be associated with one or more stored value card accounts as described in FIG. 5 above.

In sum, the screenshot 879 clearly shows how the user 827 may utilize the wireless device 828 to establish a threshold amount with the unbranded account. Thus, if the unbranded account exceeds $10.00 USD in this example, then the unbranded account balance may automatically transfer to the Diner stored value card account. In one embodiment, the hybrid m-commerce system 400 described in FIG. 4 may be invoked to transfer money between the stored value card accounts.

Turning back to the example with Alice, if Alice continued to gather change identifiers from merchants, she would amass a large balance in the unbranded account. She may wish to utilize this money and spend it at merchants. Further, she may wish to spend it at a different merchant. Therefore, setting the threshold amount to automatically transfer an amount of money to a particular stored value card account provides an effortless way for Alice to use the money she would otherwise receive as cash change.

Security is an ever-present concern with many computing systems. As such any transmitting, receiving, processing, determining, defining, etc. may be encoded, encrypted, or protected using any number of commonly known cryptography (“crypto”) techniques or cryptosystems. Examples of cryptosystems include RSA encryption, Schnorr signature, PGP encryption, El-Gamal encryption, etc. One of skill in the art will appreciate the security concerns and address them accordingly upon implementation of some embodiments.

One of skill in the art will appreciate that the some of the foregoing embodiments have described the merchant as operating a physical or “brick-and-mortar” place of business, but the proposed solution may be implemented to be used for online merchants as well. For example, Amazon.com is a large merchant of online goods and services. In one embodiment, an online merchant may utilize the marketing campaign proposed in some of the embodiments above. Further, online merchants may operate the server 110 (or a functional equivalent) within their own servers, which are already required for their online storefront. In one embodiment, these online merchants may specially brand the client module 305 and/or the server 110 in order to promote their online goods and services.

One of skill in the art will appreciate that some of the methods and systems proposed in this application may require compliance with acts preventing money laundering, racketeering, tax evasion, terrorism, etc. For instance, the system proposed herein may require the users to provide a Social Security number and state-issued driver's license before exchanging money from an unbranded gift card for cash (or vice versa). One of skill in the art will need to undertake the necessary legal research and legal compliance before deploying such a system in the marketplace. The legal requirements of each jurisdiction in the world are far beyond the scope of this document. Further, as the world progresses toward cashless economies, the laws of each jurisdiction will change accordingly.

The trademarks and trade names of entities are used in this application for illustrative purposes only such that a real-world context is given to the solutions proposed herein. The trademarks and trade names are the property of their respective owners and no affiliation or endorsement should be derived from their limited use in this detailed description.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk, High Definition DVD (“HD-DVD”) and Blu-ray disc where disks usually reproduce data magnetically, while discs reproduce data optically with lasers. Combinations of the above should also be included within the scope of computer-readable media.

Although selected embodiments have been illustrated and described in detail, it will be understood that various substitutions and alterations may be made therein without departing from the spirit and scope of the present invention, as defined by the following claims.

What is claimed is:

1. A method for mobile commerce on a wireless device, the method comprising:
defining a stored value card account, wherein the stored value account is associated with at least one merchant;
defining a cash transaction amount in response to paying cash in a transaction with a merchant, the transaction resulting in a cash change amount;
defining a first amount in response to the cash transaction amount, wherein the first amount adjusts the cash change amount resulting from the transaction;
transferring the first amount to the merchant; and
deducting the first amount from the stored value card account associated with the merchant.

2. The method of claim 1, further comprising:
defining an unbranded stored value card account, wherein the unbranded stored value card account is operable to transfer an amount to and from the stored value card account, further wherein the unbranded stored value card account is not associated at least one merchant.

3. The method of claim 1, wherein the cash change amount is a fractional dollar amount, a whole dollar amount, or combination thereof.

4. The method of claim 1, wherein the first amount is optimized to reduce coin cash change associated with the cash change amount.

5. The method of claim 1, wherein the first amount is optimized to reduce the quantity of banknotes associated with the cash change amount.

6. The method of claim 2, further comprising:
receiving a change identifier corresponding to the cash change amount, wherein the identifier is operable to adjust the balance of the unbranded account or the stored value card account.

7. The method of claim 6, wherein the change identifier is received via an email, a short message service (“SMS”) message, a microblog entry, a paper receipt, a captured photograph, a near field communication (“NFC”) transmitted message, an alphanumeric code, a barcode, or combination thereof.

8. The method of claim 6, further comprising:
redeeming the change identifier; and
adjusting the balance of the stored value card account or the unbranded stored value card account.

9. The method of claim 2, further comprising:
defining a threshold amount associated with the balance of the unbranded account;
transferring an amount from the unbranded account to the stored value card account if the threshold amount is reached or exceeded.

10. The method of claim 2, further comprising:
defining a threshold amount associated with the balance of the stored value card account; and
transferring an amount from the stored value card account to the unbranded account if the balance is below the threshold amount.

11. A wireless device for mobile commerce, the wireless device comprising:
means for defining a stored value card account, wherein the stored value account is associated with at least one merchant;
means for defining a cash transaction amount in response to paying cash in a transaction with a merchant, the transaction resulting in a cash change amount;
means for defining a first amount in response to the cash transaction amount, wherein the first amount adjusts the cash change amount resulting from the transaction;
means for transferring the first amount to the merchant; and
means for deducting the first amount from the stored value card account associated with the merchant.

12. The wireless device of claim 11, further comprising:
means for defining an unbranded stored value card account, wherein the unbranded stored value card account is operable to transfer an amount to and from the stored value card account, further wherein the unbranded stored value card account is not associated at least one merchant.

13. The wireless device of claim 11, wherein the cash change amount is a fractional dollar amount, a whole dollar amount, or combination thereof.

14. The wireless device of claim 11, wherein the first amount is optimized to reduce coin cash change associated with the cash change amount.

15. The wireless device of claim 11, wherein the first amount is optimized to reduce the quantity of banknotes associated with the cash change amount.

16. The wireless device of claim 12, further comprising:
means for receiving a change identifier corresponding to the cash change amount, wherein the identifier is operable to adjust the balance of the unbranded account or the stored value card account.

17. The wireless device of claim 16, wherein the change identifier is received via an email, a short message service (“SMS”) message, a microblog entry, a paper receipt, a captured photograph, a near field communication (“NFC”) transmitted message, an alphanumeric code, a barcode, or combination thereof.

18. The wireless device of claim 16, further comprising:
means for redeeming the change identifier; and
means for adjusting the balance of the stored value card account or the unbranded stored value card account.

19. The wireless device of claim 12, further comprising:
means for defining a threshold amount associated with the balance of the unbranded account; and
means for transferring an amount from the unbranded account to the stored value card account if the threshold amount is reached or exceeded.

20. The wireless device of claim 12, further comprising:
means for defining a threshold amount associated with the balance of the stored value card account; and
means for transferring an amount from the stored value card account to the unbranded account if the balance is below the threshold amount.

21. A computer program product comprising a computer usable medium having a computer readable program code embodied therein, said computer readable program code adapted to be executed to implement a method for mobile commerce, the method comprising:
defining a stored value card account, wherein the stored value account is associated with at least one merchant;
defining a cash transaction amount in response to paying cash in a transaction with a merchant, the transaction resulting in a cash change amount;
defining a first amount in response to the cash transaction amount, wherein the first amount adjusts the cash change amount resulting from the transaction;
transferring the first amount to the merchant; and
deducting the first amount from the stored value card account associated with the merchant.

22. The computer program product of claim 21, the method further comprising:
defining an unbranded stored value card account, wherein the unbranded stored value card account is operable to transfer an amount to and from the stored value card account, further wherein the unbranded stored value card account is not associated at least one merchant.

23. The computer program product of claim 21, wherein the cash change amount is a fractional dollar amount, a whole dollar amount, or combination thereof.

24. The computer program product of claim 21, wherein the first amount is optimized to reduce coin cash change associated with the cash change amount.

25. The computer program product of claim 21, wherein the first amount is optimized to reduce the quantity of banknotes associated with the cash change amount.

26. The computer program product of claim 22, the method further comprising:
receiving a change identifier corresponding to the cash change amount, wherein the identifier is operable to adjust the balance of the unbranded account or the stored value card account.

27. The computer program product of claim 26, wherein the change identifier is received via an email, a short message service (“SMS”) message, a microblog entry, a paper receipt, a captured photograph, a near field communication (“NFC”) transmitted message, an alphanumeric code, a barcode, or combination thereof.

28. The computer program product of claim 26, the method further comprising:
redeeming the change identifier; and
adjusting the balance of the stored value card account or the unbranded stored value card account.

29. The computer program product of claim 22, the method further comprising:
defining a threshold amount associated with the balance of the unbranded account; and
transferring an amount from the unbranded account to the stored value card account if the threshold amount is reached or exceeded.

30. The computer program product of claim 22, the method further comprising:
defining a threshold amount associated with the balance of the stored value card account; and
transferring an amount from the stored value card account to the unbranded account if the balance is below the threshold amount.

31. A wireless device for mobile commerce, the wireless device comprising:
a memory;
a transceiver; and
a processor operable to:
define a stored value card account, wherein the stored value account is associated with at least one merchant;
define a cash transaction amount in response to paying cash in a transaction with a merchant, the transaction resulting in a cash change amount;
define a first amount in response to the cash transaction amount, wherein the first amount adjusts the cash change amount resulting from the transaction;
transfer the first amount to the merchant; and
deduct the first amount from the stored value card account associated with the merchant.

32. The wireless device of claim 31, the processor further operable to:
define an unbranded stored value card account, wherein the unbranded stored value card account is operable to transfer an amount to and from the stored value card account, further wherein the unbranded stored value card account is not associated at least one merchant.

33. The wireless device of claim 31, wherein the cash change amount is a fractional dollar amount, a whole dollar amount, or combination thereof.

34. The wireless device of claim 31, wherein the first amount is optimized to reduce coin cash change associated with the cash change amount.

35. The wireless device of claim 31, wherein the first amount is optimized to reduce the quantity of banknotes associated with the cash change amount.

36. The wireless device of claim 32, the processor further operable to:
receive a change identifier via the transceiver corresponding to the cash change amount, wherein the identifier is operable to adjust the balance of the unbranded account or the stored value card account.

37. The wireless device of claim 36, wherein the change identifier is received via an email, a short message service (“SMS”) message, a microblog entry, a paper receipt, a captured photograph, a near field communication (“NFC”) transmitted message, an alphanumeric code, a barcode, or combination thereof.

38. The wireless device of claim 36, the processor further operable to:
redeem the change identifier; and
adjust the balance of the stored value card account or the unbranded stored value card account.

39. The wireless device of claim 32, the processor further operable to:
define a threshold amount associated with the balance of the unbranded account; and
transfer an amount from the unbranded account to the stored value card account if the threshold amount is reached or exceeded.

40. The wireless device of claim 32, the processor further operable to:
define a threshold amount associated with the balance of the stored value card account; and
transfer an amount from the stored value card account to the unbranded account if the balance is below the threshold amount.
